(19) United States
(12) Patent Application Publication
(10) Pub. No.: US 2021/0192856 A1
(43) Pub. Date: Jun. 24, 2021

(54) XR DEVICE AND METHOD FOR CONTROLLING THE SAME

(71) Applicant: LG ELECTRONICS INC., Seoul (KR)

(72) Inventor: Sunhyuk LEE, Seoul (KR)

(73) Assignee: LG ELECTRONICS INC., Seoul (KR)

(21) Appl. No.: 16/820,031

(22) Filed: Mar. 16, 2020

(30) Foreign Application Priority Data
Dec. 19, 2019 (KR) 10-2019-0170741

(51) Int. Cl. G06T 19/20; G06T 19/00

(52) U.S. Cl. CPC G06T 19/20; G06T 2219/2004; G06T 19/006

(57) ABSTRACT

Disclosed are an XR device and method of controlling the same. According to the preset disclosure, when a virtual object is disposed in a preview image of a camera representing a real world, if a portion of the virtual object overlaps with a portion of a real object in the preview image, the virtual object is disposed based on depths of the real and virtual objects.

This application claims the benefit of Korean Patent Application No. 10-2019-0170741, filed on Dec. 19, 2019, which is hereby incorporated by reference as if fully set forth herein.

### BACKGROUND OF THE INVENTION

### Field of the Invention

The present disclosure relates to an extended reality (XR) device for providing augmented reality (AR) mode and virtual reality (VR) mode and a method for controlling the same. More particularly, the present disclosure is applicable to all of the technical fields of 5^{th} generation (5G) communication, robots, self-driving, and artificial intelligence (AI).

### Discussion of the Related Art

Virtual reality (VR) simulates objects or a background in the real world only in computer graphic (CG) images. Augmented reality (AR) is an overlay of virtual CG images on images of objects in the real world. Mixed reality (MR) is a CG technology of merging the real world with virtual objects. All of VR, AR and MR are collectively referred to shortly as extended reality (XR).

XR technology may be applied to a Head-Mounted Display (HMD), a Head-Up Display (HUD), eyeglasses-type glasses, a mobile phone, a tablet, a laptop, a desktop computer, a TV, digital signage, etc. A device to which XR technology is applied may be referred to as an XR device.

As reality and virtuality coexist, Augmented Reality (AR) becomes reality. For example, when an assembly product is placed on a kiosk, a finished product is shown. Or, a smart mirror shows wearing a variety of clothes and accessories as if wearing real clothes. In addition, household appliances or furniture may be made into virtual objects and placed with real-world objects within a camera's preview image.

People's interest is increasing as the technology to show virtual objects together with real objects within a camera's preview image representing the real world increases. However, the technology for distance from an XR device is important because the virtual object is only placed in a certain part of the above preview image and is not hidden or hidden behind the real object.

However, if the depth of the real object in the camera's preview image is not known at the moment and the virtual object is placed in the above preview image, there is a problem that the virtual object appears to be inside the above real object, or that the above virtual object is seen before the above realistic object.

### SUMMARY OF THE INVENTION

Accordingly, the present disclosure is directed to an XR device and method for controlling the same that substantially obviate one or more problems due to limitations and disadvantages of the related art.

One object of the present disclosure is to provide an XR device and method for controlling the same, by which a virtual object may be disposed based on depths of a real object and the virtual object in case that the virtual object partially overlaps with the real object in a preview image of a camera in disposing the virtual object in the preview image of the camera representing a real world.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the disclosure, as embodied and broadly described herein, an XR device according to one embodiment of the present disclosure may include a camera receiving an image including at least one real object of a real world, a display displaying the image, a sensor obtaining depth information of the real object, and a processor, when at least one virtual object is disposed in the image, if a portion of the virtual object overlaps with a portion of the real object, the processor changing disposition of at least one of the virtual object and the real object based on depth information of the virtual object and the depth information of the real object.

In another aspect of the present disclosure, as embodied and broadly described herein, a method of controlling an XR device according to another embodiment of the present disclosure may include receiving an image including at least one real object of a real world through a camera, displaying the image, obtaining depth information of the real object through a sensor, and when at least one virtual object is disposed in the image, if a portion of the virtual object overlaps with a portion of the real object, changing disposition of at least one of the virtual object and the real object based on depth information of the virtual object and the depth information of the real object.

It is to be understood that both the foregoing general description and the following detailed description of the present disclosure are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a block diagram illustrating an artificial intelligence (AI) device 1000 according to an embodiment of the present disclosure.

FIG. 2 is a block diagram illustrating an AI server 1120 according to an embodiment of the present disclosure.

FIG. 3 is a diagram illustrating an AI system according to an embodiment of the present disclosure.

FIG. 4 is a block diagram illustrating an extended reality (XR) device according to embodiments of the present disclosure.

FIG. 5 is a detailed block diagram illustrating a memory illustrated in FIG. 4.

FIG. 6 is a block diagram illustrating a point cloud data processing system.

FIG. 7 is a block diagram illustrating an XR device 1600 including a learning processor.

FIG. 8 is a flowchart illustrating a process of providing an XR service by an XR device 1600 of the present disclosure, illustrated in FIG. 7.

FIG. 9 is a diagram illustrating the outer appearances of an XR device and a robot.

FIG. 10 is a flowchart illustrating a process of controlling a robot by using an XR device.

FIG. 11 is a diagram illustrating a vehicle that provides a self-driving service.

FIG. 12 is a flowchart illustrating a process of providing an augmented reality/virtual reality (AR/VR) service during a self-driving service in progress.

FIG. 13 is a conceptual diagram illustrating an exemplary method for implementing an XR device using an HMD type according to an embodiment of the present disclosure.

FIG. 14 is a conceptual diagram illustrating an exemplary method for implementing an XR device using AR glasses according to an embodiment of the present disclosure

FIG. 15 is a block diagram of an XR device according to one embodiment of the present disclosure.

FIG. 16 is a flowchart of a process for disposing a virtual object in an XR device according to one embodiment of the present disclosure.

FIG. 17 is a diagram to describe depth information of a real object according to one embodiment of the present disclosure.

FIG. 18 is a diagram to describe a process for recognizing and extracting a real object in a preview image according to one embodiment of the present disclosure.

FIG. 19 is a diagram to describe depth information when a virtual object is a 2D or 3D virtual object according to one embodiment of the present disclosure.

FIG. 20 is a diagram to describe a process for disposing a 2D virtual object ahead of a real object according to one embodiment of the present disclosure.

FIG. 21 is a diagram to describe a process for disposing a 2D virtual object behind a real object according to one embodiment of the present disclosure.

FIG. 22 is a diagram to describe a situation that disposition is impossible because a 2D virtual object penetrates a real object according to one embodiment of the present disclosure.

FIG. 23 is a diagram to describe a process for moving a 2D virtual object to avoid penetration into a real object according to one embodiment of the present disclosure.

FIG. 24 is a diagram to describe a process for restricting a 2D virtual object and a real object from moving in a contact direction according to one embodiment of the present disclosure.

FIG. 25 is a diagram to describe a process for disposing a 3D virtual object ahead of a real object according to one embodiment of the present disclosure.

FIG. 26 is a diagram to describe a process for disposing a 3D virtual object behind a real object according to one embodiment of the present disclosure.

FIG. 27 is a diagram to describe a situation that disposition is impossible because a 3D virtual object penetrates a real object according to one embodiment of the present disclosure.

FIG. 28 is a diagram to describe a process for moving a 3D virtual object to avoid penetration into a real object according to one embodiment of the present disclosure.

FIG. 29 is a diagram to describe a process for restricting a 3D virtual object and a real object from moving in a contact direction according to one embodiment of the present disclosure.

### DESCRIPTION OF SPECIFIC EMBODIMENTS

Reference will now be made in detail to embodiments of the present disclosure, examples of which are illustrated in the accompanying drawings. Wherever possible, the same reference numbers will be used throughout the drawings to refer to the same or like parts, and a redundant description will be avoided. The terms “module” and “unit” are interchangeably used only for easiness of description and thus they should not be considered as having distinctive meanings or roles. Further, a detailed description of well-known technology will not be given in describing embodiments of the present disclosure least it should obscure the subject matter of the embodiments. The attached drawings are provided to help the understanding of the embodiments of the present disclosure, not limiting the scope of the present disclosure. It is to be understood that the present disclosure covers various modifications, equivalents, and/or alternatives falling within the scope and spirit of the present disclosure.

The following embodiments of the present disclosure are intended to embody the present disclosure, not limiting the scope of the present disclosure. What could easily be derived from the detailed description of the present disclosure and the embodiments by a person skilled in the art is interpreted as falling within the scope of the present disclosure.

The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

Artificial Intelligence (AI)

Artificial intelligence is a field of studying AI or methodologies for creating AI, and machine learning is a field of defining various issues dealt with in the AI field and studying methodologies for addressing the various issues. Machine learning is defined as an algorithm that increases the performance of a certain operation through steady experiences for the operation.

An artificial neural network (ANN) is a model used in machine learning and may generically refer to a model having a problem-solving ability, which is composed of artificial neurons (nodes) forming a network via synaptic connections. The ANN may be defined by a connection pattern between neurons in different layers, a learning process for updating model parameters, and an activation function for generating an output value.

The ANN may include an input layer, an output layer, and optionally, one or more hidden layers. Each layer includes one or more neurons, and the ANN may include a synapse that links between neurons. In the ANN, each neuron may output the function value of the activation function, for the input of signals, weights, and deflections through the synapse.

Model parameters refer to parameters determined through learning and include a weight value of a synaptic connection and deflection of neurons. A hyperparameter means a parameter to be set in the machine learning algorithm before learning, and includes a learning rate, a repetition number, a mini batch size, and an initialization function.

The purpose of learning of the ANN may be to determine model parameters that minimize a loss function. The loss function may be used as an index to determine optimal model parameters in the learning process of the ANN.

Machine learning may be classified into supervised learning, unsupervised learning, and reinforcement learning according to learning methods.

Supervised learning may be a method of training an ANN in a state in which a label for training data is given, and the label may mean a correct answer (or result value) that the ANN should infer with respect to the input of training data to the ANN. Unsupervised learning may be a method of training an ANN in a state in which a label for training data is not given. Reinforcement learning may be a learning method in which an agent defined in a certain environment is trained to select a behavior or a behavior sequence that maximizes cumulative compensation in each state.

Machine learning, which is implemented by a deep neural network (DNN) including a plurality of hidden layers among ANNs, is also referred to as deep learning, and deep learning is part of machine learning. The following description is given with the appreciation that machine learning includes deep learning.

<Robot>

A robot may refer to a machine that automatically processes or executes a given task by its own capabilities. Particularly, a robot equipped with a function of recognizing an environment and performing an operation based on its decision may be referred to as an intelligent robot.

Robots may be classified into industrial robots, medical robots, consumer robots, military robots, and so on according to their usages or application fields.

A robot may be provided with a driving unit including an actuator or a motor, and thus perform various physical operations such as moving robot joints. Further, a movable robot may include a wheel, a brake, a propeller, and the like in a driving unit, and thus travel on the ground or fly in the air through the driving unit.

<Self-Driving>

Self-driving refers to autonomous driving, and a self-driving vehicle refers to a vehicle that travels with no user manipulation or minimum user manipulation.

For example, self-driving may include a technology of maintaining a lane while driving, a technology of automatically adjusting a speed, such as adaptive cruise control, a technology of automatically traveling along a predetermined route, and a technology of automatically setting a route and traveling along the route when a destination is set.

Vehicles may include a vehicle having only an internal combustion engine, a hybrid vehicle having both an internal combustion engine and an electric motor, and an electric vehicle having only an electric motor, and may include not only an automobile but also a train, a motorcycle, and the like.

Herein, a self-driving vehicle may be regarded as a robot having a self-driving function.

<eXtended Reality (XR)>

Extended reality is a generical term covering virtual reality (VR), augmented reality (AR), and mixed reality (MR). VR provides a real-world object and background only as a computer graphic (CG) image, AR provides a virtual CG image on a real object image, and MR is a computer graphic technology that mixes and combines virtual objects into the real world.

MR is similar to AR in that the real object and the virtual object are shown together. However, in AR, the virtual object is used as a complement to the real object, whereas in MR, the virtual object and the real object are handled equally.

XR may be applied to a head-mounted display (HMD), a head-up display (HUD), a portable phone, a tablet PC, a laptop computer, a desktop computer, a TV, a digital signage, and so on. A device to which XR is applied may be referred to as an XR device.

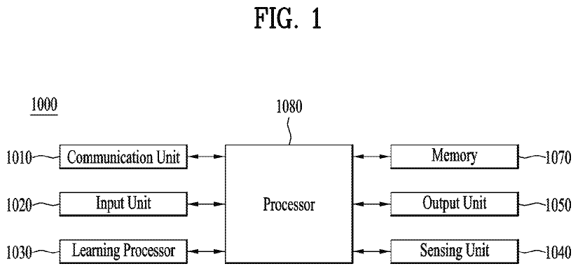

FIG. 1 is a block diagram illustrating an artificial intelligence (AI) device 1000 according to an embodiment of the present disclosure.

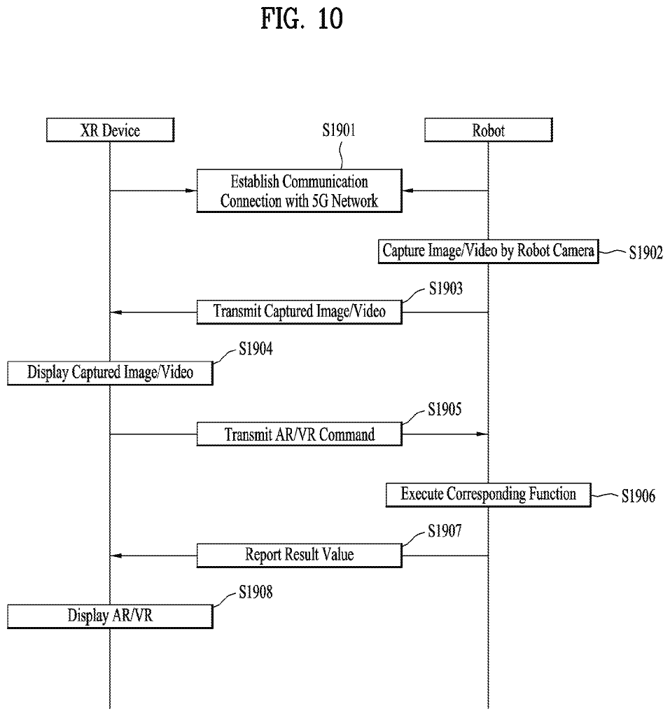

The AI device 1000 illustrated in FIG. 10 may be configured as a stationary device or a mobile device, such as a TV, a projector, a portable phone, a smartphone, a desktop computer, a laptop computer, a digital broadcasting terminal, a personal digital assistant (PDA), a portable multimedia player (PMP), a navigation device, a tablet PC, a wearable device, a set-top box (STB), a digital multimedia broadcasting (DMB) receiver, a radio, a washing machine, a refrigerator, a digital signage, a robot, or a vehicle.

Referring to FIG. 1, the AI device 1000 may include a communication unit 1010, an input unit 1020, a learning processor 1030, a sensing unit 1040, an output unit 1050, a memory 1070, and a processor 1080.

The communication unit 1010 may transmit and receive data to and from an external device such as another AI device or an AI server by wired or wireless communication. For example, the communication unit 1010 may transmit and receive sensor information, a user input, a learning model, and a control signal to and from the external device.

Communication schemes used by the communication unit 1010 include global system for mobile communication (GSM), CDMA, LTE, 5G wireless local area network (WLAN), wireless fidelity (Wi-Fi), Bluetooth™, radio frequency identification (RFID), infrared data association (IrDA), ZigBee, near field communication (NFC), and so on. Particularly, the 5G technology described.

The input unit 1020 may acquire various types of data. The input unit 1020 may include a camera for inputting a video signal, a microphone for receiving an audio signal, and a user input unit for receiving information from a user. The camera or the microphone may be treated as a sensor, and thus a signal acquired from the camera or the microphone may be referred to as sensing data or sensor information.

The input unit 1020 may acquire training data for model training and input data to be used to acquire an output by using a learning model. The input unit 1020 may acquire raw input data. In this case, the processor 1080 or the learning processor 1030 may extract an input feature by preprocessing the input data.

The learning processor 1030 may train a model composed of an ANN by using training data. The trained ANN may be referred to as a learning model. The learning model may be used to infer a result value for new input data, not training data, and the inferred value may be used as a basis for determination to perform a certain operation.

The learning processor 1030 may perform AI processing together with a learning processor of an AI server.

The learning processor 1030 may include a memory integrated or implemented in the AI device 1000. Alternatively, the learning processor 1030 may be implemented by using the memory 1070, an external memory directly connected to the AI device 1000, or a memory maintained in an external device.

The sensing unit 1040 may acquire at least one of internal information about the AI device 1000, ambient environment information about the AI device 1000, and user information by using various sensors.

The sensors included in the sensing unit 1040 may include a proximity sensor, an illumination sensor, an accelerator sensor, a magnetic sensor, a gyro sensor, an inertial sensor, a red, green, blue (RGB) sensor, an IR sensor, a fingerprint recognition sensor, an ultrasonic sensor, an optical sensor, a microphone, a light detection and ranging (LiDAR), and a radar.

The output unit 1050 may generate a visual, auditory, or haptic output.

Accordingly, the output unit 1050 may include a display unit for outputting visual information, a speaker for outputting auditory information, and a haptic module for outputting haptic information.

The memory 1070 may store data that supports various functions of the AI device 1000. For example, the memory 1070 may store input data acquired by the input unit 1020, training data, a learning model, a learning history, and so on.

The processor 1080 may determine at least one executable operation of the AI device 100 based on information determined or generated by a data analysis algorithm or a machine learning algorithm. The processor 1080 may control the components of the AI device 1000 to execute the determined operation.

To this end, the processor 1080 may request, search, receive, or utilize data of the learning processor 1030 or the memory 1070. The processor 1080 may control the components of the AI device 1000 to execute a predicted operation or an operation determined to be desirable among the at least one executable operation.

When the determined operation needs to be performed in conjunction with an external device, the processor 1080 may generate a control signal for controlling the external device and transmit the generated control signal to the external device.

The processor 1080 may acquire intention information with respect to a user input and determine the user's requirements based on the acquired intention information.

The processor 1080 may acquire the intention information corresponding to the user input by using at least one of a speech to text (STT) engine for converting a speech input into a text string or a natural language processing (NLP) engine for acquiring intention information of a natural language.

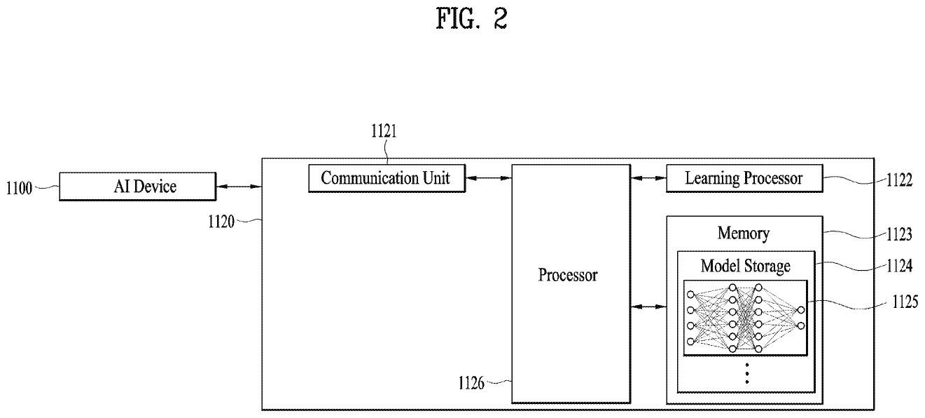

At least one of the STT engine or the NLP engine may be configured as an ANN, at least part of which is trained according to the machine learning algorithm. At least one of the STT engine or the NLP engine may be trained by the learning processor, a learning processor of the AI server, or distributed processing of the learning processors. For reference, specific components of the AI server are illustrated in FIG. 2.

The processor 1080 may collect history information including the operation contents of the AI device 1000 or the user's feedback on the operation and may store the collected history information in the memory 1070 or the learning processor 1030 or transmit the collected history information to the external device such as the AI server. The collected history information may be used to update the learning model.

The processor 1080 may control at least a part of the components of AI device 1000 so as to drive an application program stored in the memory 1070. Furthermore, the processor 1080 may operate two or more of the components included in the AI device 1000 in combination so as to drive the application program.

FIG. 2 is a block diagram illustrating an AI server 1120 according to an embodiment of the present disclosure.

Referring to FIG. 2, the AI server 1120 may refer to a device that trains an ANN by a machine learning algorithm or uses a trained ANN. The AI server 1120 may include a plurality of servers to perform distributed processing, or may be defined as a 5G network. The AI server 1120 may be included as part of the AI device 1100, and perform at least part of the AI processing.

The AI server 1120 may include a communication unit 1121, a memory 1123, a learning processor 1122, a processor 1126, and so on.

The communication unit 1121 may transmit and receive data to and from an external device such as the AI device 1100.

The memory 1123 may include a model storage 1124. The model storage 1124 may store a model (or an ANN 1125) which has been trained or is being trained through the learning processor 1122.

The learning processor 1122 may train the ANN 1125 by training data. The learning model may be used, while being loaded on the AI server 1120 of the ANN, or on an external device such as the AI device 1110.

The learning model may be implemented in hardware, software, or a combination of hardware and software. If all or part of the learning model is implemented in software, one or more instructions of the learning model may be stored in the memory 1123.

The processor 1126 may infer a result value for new input data by using the learning model and may generate a response or a control command based on the inferred result value.

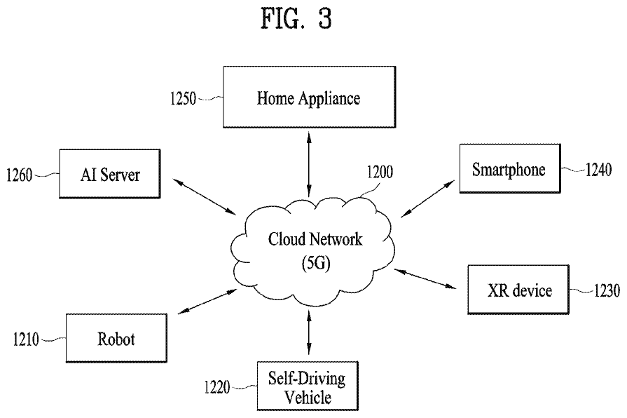

FIG. 3 is a diagram illustrating an AI system according to an embodiment of the present disclosure.

Referring to FIG. 3, in the AI system, at least one of an AI server 1260, a robot 1210, a self-driving vehicle 1220, an XR device 1230, a smartphone 1240, or a home appliance 1250 is connected to a cloud network 1200. The robot 1210, the self-driving vehicle 1220, the XR device 1230, the smartphone 1240, or the home appliance 1250, to which AI is applied, may be referred to as an AI device.

The cloud network 1200 may refer to a network that forms part of cloud computing infrastructure or exists in the cloud computing infrastructure. The cloud network 1200 may be configured by using a 3G network, a 4G or LTE network, or a 5G network.

That is, the devices 1210 to 1260 included in the AI system may be interconnected via the cloud network 1200. In particular, each of the devices 1210 to 1260 may communicate with each other directly or through a BS.

The AI server 1260 may include a server that performs AI processing and a server that performs computation on big data.

The AI server 1260 may be connected to at least one of the AI devices included in the AI system, that is, at least one of the robot 1210, the self-driving vehicle 1220, the XR device 1230, the smartphone 1240, or the home appliance 1250 via the cloud network 1200, and may assist at least part of AI processing of the connected AI devices 1210 to 1250.

The AI server 1260 may train the ANN according to the machine learning algorithm on behalf of the AI devices 1210 to 1250, and may directly store the learning model or transmit the learning model to the AI devices 1210 to 1250.

The AI server 1260 may receive input data from the AI devices 1210 to 1250, infer a result value for received input data by using the learning model, generate a response or a control command based on the inferred result value, and transmit the response or the control command to the AI devices 1210 to 1250.

Alternatively, the AI devices 1210 to 1250 may infer the result value for the input data by directly using the learning model, and generate the response or the control command based on the inference result.

Hereinafter, various embodiments of the AI devices 1210 to 1250 to which the above-described technology is applied will be described. The AI devices 1210 to 1250 illustrated in FIG. 3 may be regarded as a specific embodiment of the AI device 1000 illustrated in FIG. 1.

<AI+XR>

The XR device 1230, to which AI is applied, may be configured as a HMD, a HUD provided in a vehicle, a TV, a portable phone, a smartphone, a computer, a wearable device, a home appliance, a digital signage, a vehicle, a fixed robot, a mobile robot, or the like.

The XR device 1230 may acquire information about a surrounding space or a real object by analyzing 3D point cloud data or image data acquired from various sensors or an external device and thus generating position data and attribute data for the 3D points, and may render an XR object to be output. For example, the XR device 1230 may output an XR object including additional information about a recognized object in correspondence with the recognized object.

The XR device 1230 may perform the above-described operations by using the learning model composed of at least one ANN. For example, the XR device 1230 may recognize a real object from 3D point cloud data or image data by using the learning model, and may provide information corresponding to the recognized real object. The learning model may be trained directly by the XR device 1230 or by the external device such as the AI server 1260.

While the XR device 1230 may operate by generating a result by directly using the learning model, the XR device 1230 may operate by transmitting sensor information to the external device such as the AI server 1260 and receiving the result.

<AI+Robot+XR>

The robot 1210, to which AI and XR are applied, may be implemented as a guide robot, a delivery robot, a cleaning robot, a wearable robot, an entertainment robot, a pet robot, an unmanned flying robot, a drone, or the like.

The robot 1210, to which XR is applied, may refer to a robot to be controlled/interact within an XR image. In this case, the robot 1210 may be distinguished from the XR device 1230 and interwork with the XR device 1230.

When the robot 1210 to be controlled/interact within an XR image acquires sensor information from sensors each including a camera, the robot 1210 or the XR device 1230 may generate an XR image based on the sensor information, and the XR device 1230 may output the generated XR image. The robot 1210 may operate based on the control signal received through the XR device 1230 or based on the user's interaction.

For example, the user may check an XR image corresponding to a view of the robot 1210 interworking remotely through an external device such as the XR device 1210, adjust a self-driving route of the robot 1210 through interaction, control the operation or driving of the robot 1210, or check information about an ambient object around the robot 1210.

<AI+Self-Driving+XR>

The self-driving vehicle 1220, to which AI and XR are applied, may be implemented as a mobile robot, a vehicle, an unmanned flying vehicle, or the like.

The self-driving driving vehicle 1220, to which XR is applied, may refer to a self-driving vehicle provided with a means for providing an XR image or a self-driving vehicle to be controlled/interact within an XR image. Particularly, the self-driving vehicle 1220 to be controlled/interact within an XR image may be distinguished from the XR device 1230 and interwork with the XR device 1230.

The self-driving vehicle 1220 provided with the means for providing an XR image may acquire sensor information from the sensors each including a camera and output the generated XR image based on the acquired sensor information. For example, the self-driving vehicle 1220 may include an HUD to output an XR image, thereby providing a passenger with an XR object corresponding to a real object or an object on the screen.

When the XR object is output to the HUD, at least part of the XR object may be output to be overlaid on an actual object to which the passenger's gaze is directed. When the XR object is output to a display provided in the self-driving vehicle 1220, at least part of the XR object may be output to be overlaid on the object within the screen. For example, the self-driving vehicle 1220 may output XR objects corresponding to objects such as a lane, another vehicle, a traffic light, a traffic sign, a two-wheeled vehicle, a pedestrian, a building, and so on.

When the self-driving vehicle 1220 to be controlled/interact within an XR image acquires sensor information from the sensors each including a camera, the self-driving vehicle 1220 or the XR device 1230 may generate the XR image based on the sensor information, and the XR device 1230 may output the generated XR image. The self-driving vehicle 1220 may operate based on a control signal received through an external device such as the XR device 1230 or based on the user's interaction.

VR, AR, and MR technologies of the present disclosure are applicable to various devices, particularly, for example, a HMD, a HUD attached to a vehicle, a portable phone, a tablet PC, a laptop computer, a desktop computer, a TV, and a signage. The VR, AR, and MR technologies may also be applicable to a device equipped with a flexible or rollable display.

The above-described VR, AR, and MR technologies may be implemented based on CG and distinguished by the ratios of a CG image in an image viewed by the user.

That is, VR provides a real object or background only in a CG image, whereas AR overlays a virtual CG image on an image of a real object.

MR is similar to AR in that virtual objects are mixed and combined with a real world. However, a real object and a virtual object created as a CG image are distinctive from each other and the virtual object is used to complement the real object in AR, whereas a virtual object and a real object are handled equally in MR. More specifically, for example, a hologram service is an MR representation.

These days, VR, AR, and MR are collectively called XR without distinction among them. Therefore, embodiments of the present disclosure are applicable to all of VR, AR, MR, and XR.

For example, wired/wireless communication, input interfacing, output interfacing, and computing devices are available as hardware (HW)-related element techniques applied to VR, AR, MR, and XR. Further, tracking and matching, speech recognition, interaction and user interfacing, location-based service, search, and AI are available as software (SW)-related element techniques.

Particularly, the embodiments of the present disclosure are intended to address at least one of the issues of communication with another device, efficient memory use, data throughput decrease caused by inconvenient user experience/user interface (UX/UI), video, sound, motion sickness, or other issues.

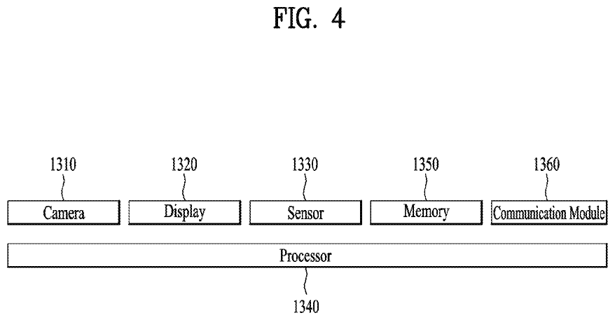

FIG. 4 is a block diagram illustrating an extended reality (XR) device according to embodiments of the present disclosure. The XR device 1300 includes a camera 1310, a display 1320, a sensor 1330, a processor 1340, a memory 1350, and a communication module 1360. Obviously, one or more of the modules may be deleted or modified, and one or more modules may be added to the modules, when needed, without departing from the scope and spirit of the present disclosure.

The communication module 1360 may communicate with an external device or a server, wiredly or wirelessly. The communication module 1360 may use, for example, Wi-Fi, Bluetooth, or the like, for short-range wireless communication, and for example, a 3GPP communication standard for long-range wireless communication. LTE is a technology beyond 3GPP TS 36.xxx Release 8. Specifically, LTE beyond 3GPP TS 36.xxx Release 10 is referred to as LTE-A, and LTE beyond 3GPP TS 36.xxx Release 13 is referred to as LTE-A pro. 3GPP 5G refers to a technology beyond TS 36.xxx Release 15 and a technology beyond TS 38.XXX Release 15. Specifically, the technology beyond TS 38.xxx Release 15 is referred to as 3GPP NR, and the technology beyond TS 36.xxx Release 15 is referred to as enhanced LTE. “xxx” represents the number of a technical specification. LTE/NR may be collectively referred to as a 3GPP system.

The camera 1310 may capture an ambient environment of the XR device 1300 and convert the captured image to an electric signal. The image, which has been captured and converted to an electric signal by the camera 1310, may be stored in the memory 1350 and then displayed on the display 1320 through the processor 1340. Further, the image may be displayed on the display 1320 by the processor 1340, without being stored in the memory 1350. Further, the camera 110 may have a field of view (FoV). The FoV is, for example, an area in which a real object around the camera 1310 may be detected. The camera 1310 may detect only a real object within the FoV. When a real object is located within the FoV of the camera 1310, the XR device 1300 may display an AR object corresponding to the real object. Further, the camera 1310 may detect an angle between the camera 1310 and the real object.

The sensor 1330 may include at least one sensor. For example, the sensor 1330 includes a sensing means such as a gravity sensor, a geomagnetic sensor, a motion sensor, a gyro sensor, an accelerator sensor, an inclination sensor, a brightness sensor, an altitude sensor, an olfactory sensor, a temperature sensor, a depth sensor, a pressure sensor, a bending sensor, an audio sensor, a video sensor, a global positioning system (GPS) sensor, and a touch sensor. Further, although the display 1320 may be of a fixed type, the display 1320 may be configured as a liquid crystal display (LCD), an organic light emitting diode (OLED) display, an electroluminescent display (ELD), or a micro LED (M-LED) display, to have flexibility. Herein, the sensor 1330 is designed to detect a bending degree of the display 1320 configured as the afore-described LCD, OLED display, ELD, or M-LED display.

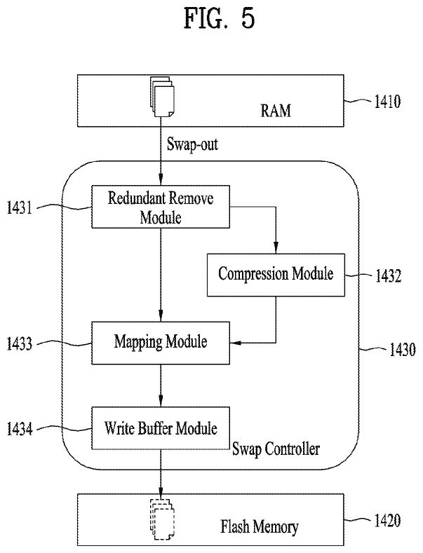

The memory 1350 is equipped with a function of storing all or a part of result values obtained by wired/wireless communication with an external device or a service as well as a function of storing an image captured by the camera 1310. Particularly, considering the trend toward increased communication data traffic (e.g., in a 5G communication environment), efficient memory management is required. In this regard, a description will be given below with reference to FIG. 5.

FIG. 5 is a detailed block diagram illustrating a memory illustrated in FIG. 4. With reference to FIG. 5, a swap-out process between a random access memory (RAM) and a flash memory according to an embodiment of the present disclosure will be described.

When swapping out AR/VR page data from a RAM 1410 to a flash memory 1420, a controller 1430 may swap out only one of two or more AR/VR page data of the same contents among AR/VR page data to be swapped out to the flash memory 1420.

That is, the controller 1430 may calculate an identifier (e.g., a hash function) that identifies each of the contents of the AR/VR page data to be swapped out, and determine that two or more AR/VR page data having the same identifier among the calculated identifiers contain the same contents. Accordingly, the problem that the lifetime of an AR/VR device including the flash memory 1420 as well as the lifetime of the flash memory 1420 is reduced because unnecessary AR/VR page data is stored in the flash memory 1420 may be overcome.

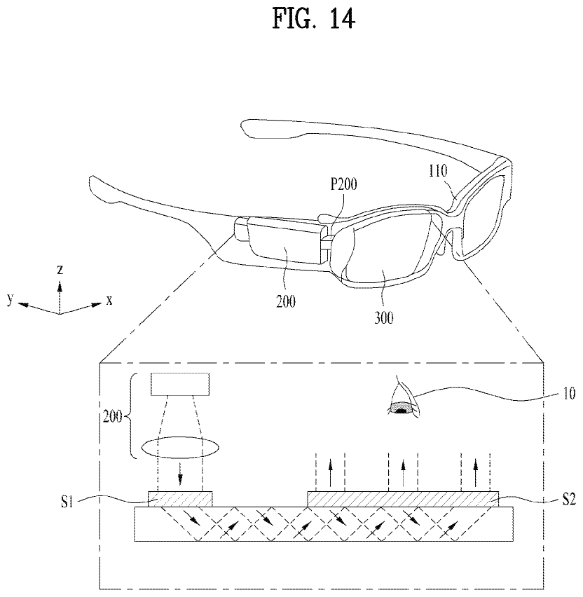

The operations of the controller 1430 may be implemented in software or hardware without departing from the scope of the present disclosure. More specifically, the memory illustrated in FIG. 14 is included in a HMD, a vehicle, a portable phone, a tablet PC, a laptop computer, a desktop computer, a TV, a signage, or the like, and executes a swap function.

A device according to embodiments of the present disclosure may process 3D point cloud data to provide various services such as VR, AR, MR, XR, and self-driving to a user.

A sensor collecting 3D point cloud data may be any of, for example, a LiDAR, a red, green, blue depth (RGB-D), and a 3D laser scanner. The sensor may be mounted inside or outside of a HMD, a vehicle, a portable phone, a tablet PC, a laptop computer, a desktop computer, a TV, a signage, or the like.

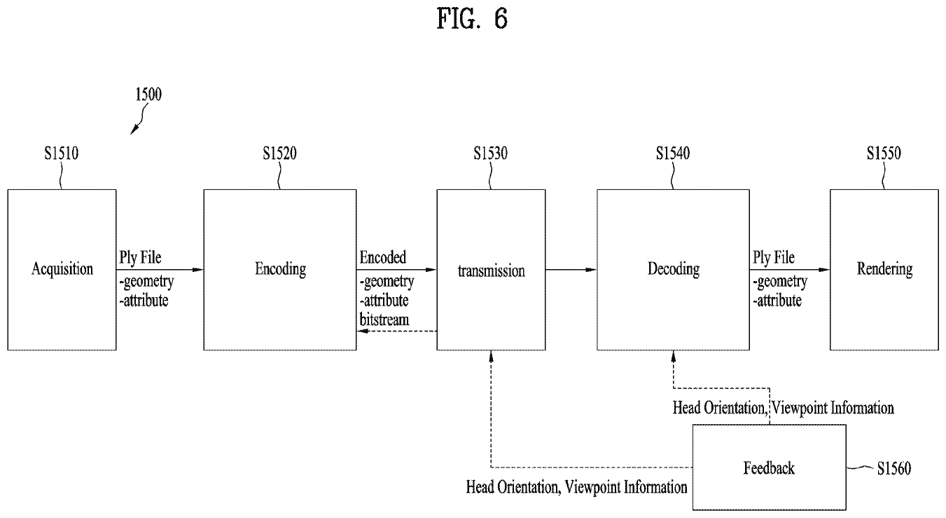

FIG. 6 is a block diagram illustrating a point cloud data processing system.

Referring to FIG. 6, a point cloud processing system 1500 includes a transmission device which acquires, encodes, and transmits point cloud data, and a reception device which acquires point cloud data by receiving and decoding video data. As illustrated in FIG. 6, point cloud data according to embodiments of the present disclosure may be acquired by capturing, synthesizing, or generating the point cloud data (S1510). During the acquisition, data (e.g., a polygon file format or standard triangle format (PLY) file) of 3D positions (x, y, z)/attributes (color, reflectance, transparency, and so on) of points may be generated. For a video of multiple frames, one or more files may be acquired. Point cloud data-related metadata (e.g., metadata related to capturing) may be generated during the capturing. The transmission device or encoder according to embodiments of the present disclosure may encode the point cloud data by video-based point cloud compression (V-PCC) or geometry-based point cloud compression (G-PCC), and output one or more video streams (S1520). V-PCC is a scheme of compressing point cloud data based on a 2D video codec such as high efficiency video coding (HEVC) or versatile video coding (VVC), G-PCC is a scheme of encoding point cloud data separately into two streams: geometry and attribute. The geometry stream may be generated by reconstructing and encoding position information about points, and the attribute stream may be generated by reconstructing and encoding attribute information (e.g., color) related to each point. In V-PCC, despite compatibility with a 2D video, much data is required to recover V-PCC-processed data (e.g., geometry video, attribute video, occupancy map video, and auxiliary information), compared to G-PCC, thereby causing a long latency in providing a service. One or more output bit streams may be encapsulated along with related metadata in the form of a file (e.g., a file format such as ISOBMFF) and transmitted over a network or through a digital storage medium (S1530).

The device or processor according to embodiments of the present disclosure may acquire one or more bit streams and related metadata by decapsulating the received video data, and recover 3D point cloud data by decoding the acquired bit streams in V-PCC or G-PCC (S1540). A renderer may render the decoded point cloud data and provide content suitable for VR/AR/MR/service to the user on a display (S1550).

As illustrated in FIG. 6, the device or processor according to embodiments of the present disclosure may perform a feedback process of transmitting various pieces of feedback information acquired during the rendering/display to the transmission device or to the decoding process (S1560). The feedback information according to embodiments of the present disclosure may include head orientation information, viewport information indicating an area that the user is viewing, and so on. Because the user interacts with a service (or content) provider through the feedback process, the device according to embodiments of the present disclosure may provide a higher data processing speed by using the afore-described V-PCC or G-PCC scheme or may enable clear video construction as well as provide various services in consideration of high user convenience.

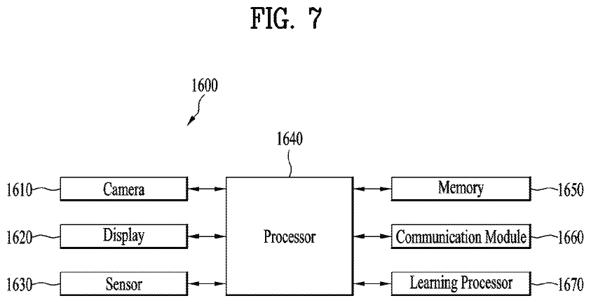

FIG. 7 is a block diagram illustrating an XR device 1600 including a learning processor. Compared to FIG. 4, only a learning processor 1670 is added, and thus a redundant description is avoided because FIG. 4 may be referred to for the other components.

Referring to FIG. 7, the XR device 1600 may be loaded with a learning model. The learning model may be implemented in hardware, software, or a combination of hardware and software. If the whole or part of the learning model is implemented in software, one or more instructions that form the learning model may be stored in a memory 1650.

According to embodiments of the present disclosure, a learning processor 1670 may be coupled communicably to a processor 1640, and repeatedly train a model including ANNs by using training data. An ANN is an information processing system in which multiple neurons are linked in layers, modeling an operation principle of biological neurons and links between neurons. An ANN is a statistical learning algorithm inspired by a neural network (particularly the brain in the central nervous system of an animal) in machine learning and cognitive science. Machine learning is one field of AI, in which the ability of learning without an explicit program is granted to a computer. Machine learning is a technology of studying and constructing a system for learning, predicting, and improving its capability based on empirical data, and an algorithm for the system. Therefore, according to embodiments of the present disclosure, the learning processor 1670 may infer a result value from new input data by determining optimized model parameters of an ANN. Therefore, the learning processor 1670 may analyze a device use pattern of a user based on device use history information about the user. Further, the learning processor 1670 may be configured to receive, classify, store, and output information to be used for data mining, data analysis, intelligent decision, and a machine learning algorithm and technique.

According to embodiments of the present disclosure, the processor 1640 may determine or predict at least one executable operation of the device based on data analyzed or generated by the learning processor 1670. Further, the processor 1640 may request, search, receive, or use data of the learning processor 1670, and control the XR device 1600 to perform a predicted operation or an operation determined to be desirable among the at least one executable operation. According to embodiments of the present disclosure, the processor 1640 may execute various functions of realizing intelligent emulation (i.e., knowledge-based system, reasoning system, and knowledge acquisition system). The various functions may be applied to an adaptation system, a machine learning system, and various types of systems including an ANN (e.g., a fuzzy logic system). That is, the processor 1640 may predict a user's device use pattern based on data of a use pattern analyzed by the learning processor 1670, and control the XR device 1600 to provide a more suitable XR service to the UE. Herein, the XR service includes at least one of the AR service, the VR service, or the MR service.

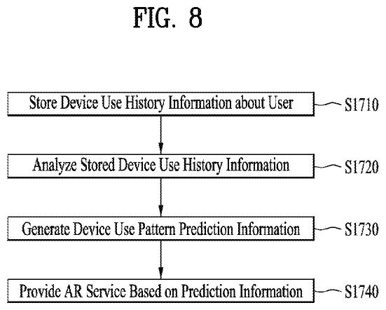

FIG. 8 is a flowchart illustrating a process of providing an XR service by an XR device 1600 of the present disclosure, illustrated in FIG. 7.

According to embodiments of the present disclosure, the processor 1670 may store device use history information about a user in the memory 1650 (S1710). The device use history information may include information about the name, category, and contents of content provided to the user, information about a time at which a device has been used, information about a place in which the device has been used, time information, and information about use of an application installed in the device.

According to embodiments of the present disclosure, the learning processor 1670 may acquire device use pattern information about the user by analyzing the device use history information (S1720). For example, when the XR device 1600 provides specific content A to the user, the learning processor 1670 may learn information about a pattern of the device used by the user using the corresponding terminal by combining specific information about content A (e.g., information about the ages of users that generally use content A, information about the contents of content A, and content information similar to content A), and information about the time points, places, and number of times in which the user using the corresponding terminal has consumed content A.

According to embodiments of the present disclosure, the processor 1640 may acquire the user device pattern information generated based on the information learned by the learning processor 1670, and generate device use pattern prediction information (S1730). Further, when the user is not using the device 1600, if the processor 1640 determines that the user is located in a place where the user has frequently used the device 1600, or it is almost time for the user to usually use the device 1600, the processor 1640 may indicate the device 1600 to operate. In this case, the device according to embodiments of the present disclosure may provide AR content based on the user pattern prediction information (S1740).

When the user is using the device 1600, the processor 1640 may check information about content currently provided to the user, and generate device use pattern prediction information about the user in relation to the content (e.g., when the user requests other related content or additional data related to the current content). Further, the processor 1640 may provide AR content based on the device use pattern prediction information by indicating the device 1600 to operate (S1740). The AR content according to embodiments of the present disclosure may include an advertisement, navigation information, danger information, and so on.

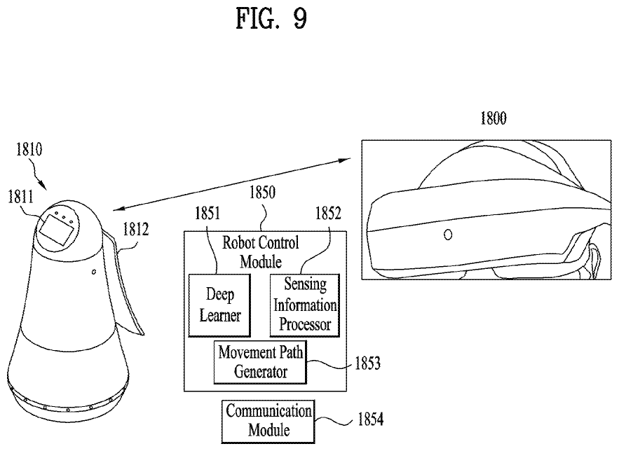

FIG. 9 is a diagram illustrating the outer appearances of an XR device and a robot.

Component modules of an XR device 1800 according to an embodiment of the present disclosure have been described before with reference to the previous drawings, and thus a redundant description is not provided herein.

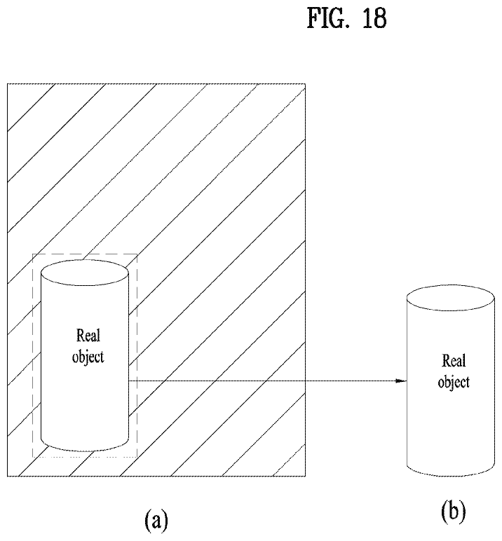

The outer appearance of a robot 1810 illustrated in FIG. 9 is merely an example, and the robot 1810 may be implemented to have various outer appearances according to the present disclosure. For example, the robot 1810 illustrated in FIG. 18 may be a drone, a cleaner, a cook root, a wearable robot, or the like. Particularly, each component of the robot 1810 may be disposed at a different position such as up, down, left, right, back, or forth according to the shape of the robot 1810.

The robot 1810 may be provided, on the exterior thereof, with various sensors to identify ambient objects. Further, to provide specific information to a user, the robot 1810 may be provided with an interface unit 1811 on top or the rear surface 1812 thereof.

To sense movement of the robot 1810 and an ambient object, and control the robot 1810, a robot control module 1850 is mounted inside the robot 1810. The robot control module 1850 may be implemented as a software module or a hardware chip with the software module implemented therein. The robot control module 1850 may include a deep learner 1851, a sensing information processor 1852, a movement path generator 1853, and a communication module 1854.

The sensing information processor 1852 collects and processes information sensed by various types of sensors (e.g., a LiDAR sensor, an IR sensor, an ultrasonic sensor, a depth sensor, an image sensor, and a microphone) arranged in the robot 1810.

The deep learner 1851 may receive information processed by the sensing information processor 1851 or accumulative information stored during movement of the robot 1810, and output a result required for the robot 1810 to determine an ambient situation, process information, or generate a moving path.

The moving path generator 1852 may calculate a moving path of the robot 1810 by using the data calculated by the deep learner 8151 or the data processed by the sensing information processor 1852.

Because each of the XR device 1800 and the robot 1810 is provided with a communication module, the XR device 1800 and the robot 1810 may transmit and receive data by short-range wireless communication such as Wi-Fi or Bluetooth, or 5G long-range wireless communication. A technique of controlling the robot 1810 by using the XR device 1800 will be described below with reference to FIG. 10.

FIG. 10 is a flowchart illustrating a process of controlling a robot by using an XR device.

The XR device and the robot are connected communicably to a 5G network (S1901). Obviously, the XR device and the robot may transmit and receive data by any other short-range or long-range communication technology without departing from the scope of the present disclosure.

The robot captures an image/video of the surroundings of the robot by means of at least one camera installed on the interior or exterior of the robot (S1902) and transmits the captured image/video to the XR device (S1903). The XR device displays the captured image/video (S1904) and transmits a command for controlling the robot to the robot (S1905). The command may be input manually by a user of the XR device or automatically generated by AI without departing from the scope of the disclosure.

The robot executes a function corresponding to the command received in step S1905 (S1906) and transmits a result value to the XR device (S1907). The result value may be a general indicator indicating whether data has been successfully processed or not, a current captured image, or specific data in which the XR device is considered. The specific data is designed to change, for example, according to the state of the XR device. If a display of the XR device is in an off state, a command for turning on the display of the XR device is included in the result value in step S1907. Therefore, when an emergency situation occurs around the robot, even though the display of the remote XR device is turned off, a notification message may be transmitted.

AR/VR content is displayed according to the result value received in step S1907 (S1908).

According to another embodiment of the present disclosure, the XR device may display position information about the robot by using a GPS module attached to the robot.

The XR device 1300 described with reference to FIG. 4 may be connected to a vehicle that provides a self-driving service in a manner that allows wired/wireless communication, or may be mounted on the vehicle that provides the self-driving service. Accordingly, various services including AR/VR may be provided even in the vehicle that provides the self-driving service.

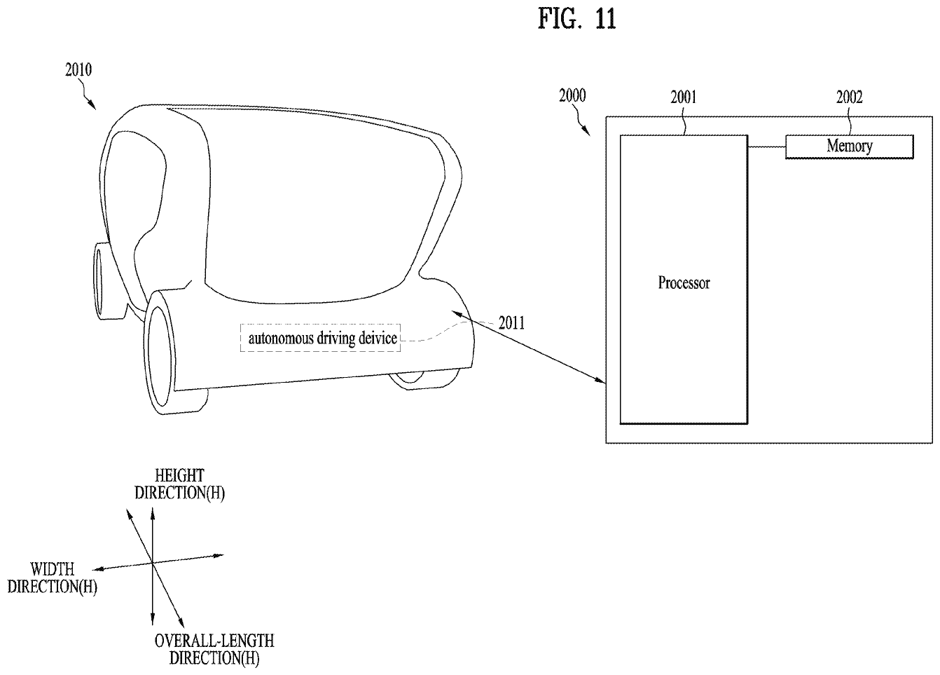

FIG. 11 is a diagram illustrating a vehicle that provides a self-driving service.

According to embodiments of the present disclosure, a vehicle 2010 may include a car, a train, and a motor bike as transportation means traveling on a road or a railway. According to embodiments of the present disclosure, the vehicle 2010 may include all of an internal combustion engine vehicle provided with an engine as a power source, a hybrid vehicle provided with an engine and an electric motor as a power source, and an electric vehicle provided with an electric motor as a power source.

According to embodiments of the present disclosure, the vehicle 2010 may include the following components in order to control operations of the vehicle 2010: a user interface device, an object detection device, a communication device, a driving maneuver device, a main electronic control unit (ECU), a drive control device, a self-driving device, a sensing unit, and a position data generation device.

Each of the user interface device, the object detection device, the communication device, the driving maneuver device, the main ECU, the drive control device, the self-driving device, the sensing unit, and the position data generation device may generate an electric signal, and be implemented as an electronic device that exchanges electric signals.

The user interface device may receive a user input and provide information generated from the vehicle 2010 to a user in the form of a UI or UX. The user interface device may include an input/output (I/O) device and a user monitoring device. The object detection device may detect the presence or absence of an object outside of the vehicle 2010, and generate information about the object. The object detection device may include at least one of, for example, a camera, a LiDAR, an IR sensor, or an ultrasonic sensor. The camera may generate information about an object outside of the vehicle 2010. The camera may include one or more lenses, one or more image sensors, and one or more processors for generating object information. The camera may acquire information about the position, distance, or relative speed of an object by various image processing algorithms. Further, the camera may be mounted at a position where the camera may secure an FoV in the vehicle 2010, to capture an image of the surroundings of the vehicle 1020, and may be used to provide an AR/VR-based service. The LiDAR may generate information about an object outside of the vehicle 2010. The LiDAR may include a light transmitter, a light receiver, and at least one processor which is electrically coupled to the light transmitter and the light receiver, processes a received signal, and generates data about an object based on the processed signal.

The communication device may exchange signals with a device (e.g., infrastructure such as a server or a broadcasting station), another vehicle, or a terminal) outside of the vehicle 2010. The driving maneuver device is a device that receives a user input for driving. In manual mode, the vehicle 2010 may travel based on a signal provided by the driving maneuver device. The driving maneuver device may include a steering input device (e.g., a steering wheel), an acceleration input device (e.g., an accelerator pedal), and a brake input device (e.g., a brake pedal).

The sensing unit may sense a state of the vehicle 2010 and generate state information. The position data generation device may generate position data of the vehicle 2010. The position data generation device may include at least one of a GPS or a differential global positioning system (DGPS). The position data generation device may generate position data of the vehicle 2010 based on a signal generated from at least one of the GPS or the DGPS. The main ECU may provide overall control to at least one electronic device provided in the vehicle 2010, and the drive control device may electrically control a vehicle drive device in the vehicle 2010.

The self-driving device may generate a path for the self-driving service based on data acquired from the object detection device, the sensing unit, the position data generation device, and so on. The self-driving device may generate a driving plan for driving along the generated path, and generate a signal for controlling movement of the vehicle according to the driving plan. The signal generated from the self-driving device is transmitted to the drive control device, and thus the drive control device may control the vehicle drive device in the vehicle 2010.

As illustrated in FIG. 11, the vehicle 2010 that provides the self-driving service is connected to an XR device 2000 in a manner that allows wired/wireless communication. The XR device 2000 may include a processor 2001 and a memory 2002. While not shown, the XR device 2000 of FIG. 11 may further include the components of the XR device 1300 described before with reference to FIG. 4.

If the XR device 2000 is connected to the vehicle 2010 in a manner that allows wired/wireless communication. The XR device 2000 may receive/process AR/VR service-related content data that may be provided along with the self-driving service, and transmit the received/processed AR/VR service-related content data to the vehicle 2010. Further, when the XR device 2000 is mounted on the vehicle 2010, the XR device 2000 may receive/process AR/VR service-related content data according to a user input signal received through the user interface device and provide the received/processed AR/VR service-related content data to the user. In this case, the processor 2001 may receive/process the AR/VR service-related content data based on data acquired from the object detection device, the sensing unit, the position data generation device, the self-driving device, and so on. According to embodiments of the present disclosure, the AR/VR service-related content data may include entertainment content, weather information, and so on which are not related to the self-driving service as well as information related to the self-driving service such as driving information, path information for the self-driving service, driving maneuver information, vehicle state information, and object information.

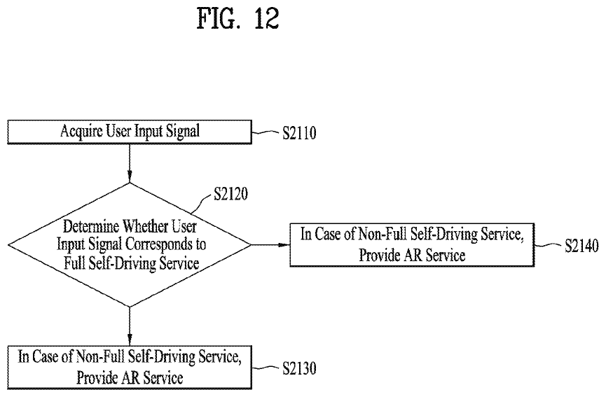

FIG. 12 is a flowchart illustrating a process of providing an augmented reality/virtual reality (AR/VR) service during a self-driving service in progress.

According to embodiments of the present disclosure, a vehicle or a user interface device may receive a user input signal (S2110). According to embodiments of the present disclosure, the user input signal may include a signal indicating a self-driving service. According to embodiments of the present disclosure, the self-driving service may include a full self-driving service and a general self-driving service. The full self-driving service refers to perfect self-driving of a vehicle to a destination without a user's manual driving, whereas the general self-driving service refers to driving a vehicle to a destination through a user's manual driving and self-driving in combination.

It may be determined whether the user input signal according to embodiments of the present disclosure corresponds to the full self-driving service (S2120). When it is determined that the user input signal corresponds to the full self-driving service, the vehicle according to embodiments of the present disclosure may provide the full self-driving service (S2130). Because the full self-driving service does not need the user's manipulation, the vehicle according to embodiments of the present disclosure may provide VR service-related content to the user through a window of the vehicle, a side mirror of the vehicle, an HMD, or a smartphone (S2130). The VR service-related content according to embodiments of the present disclosure may be content related to full self-driving (e.g., navigation information, driving information, and external object information), and may also be content which is not related to full self-driving according to user selection (e.g., weather information, a distance image, a nature image, and a voice call image).

If it is determined that the user input signal does not correspond to the full self-driving service, the vehicle according to embodiments of the present disclosure may provide the general self-driving service (S2140). Because the FoV of the user should be secured for the user's manual driving in the general self-driving service, the vehicle according to embodiments of the present disclosure may provide AR service-related content to the user through a window of the vehicle, a side mirror of the vehicle, an HMD, or a smartphone (S2140).

The AR service-related content according to embodiments of the present disclosure may be content related to full self-driving (e.g., navigation information, driving information, and external object information), and may also be content which is not related to self-driving according to user selection (e.g., weather information, a distance image, a nature image, and a voice call image).

While the present disclosure is applicable to all the fields of 5G communication, robot, self-driving, and AI as described before, the following description will be given mainly of the present disclosure applicable to an XR device with reference to following figures.

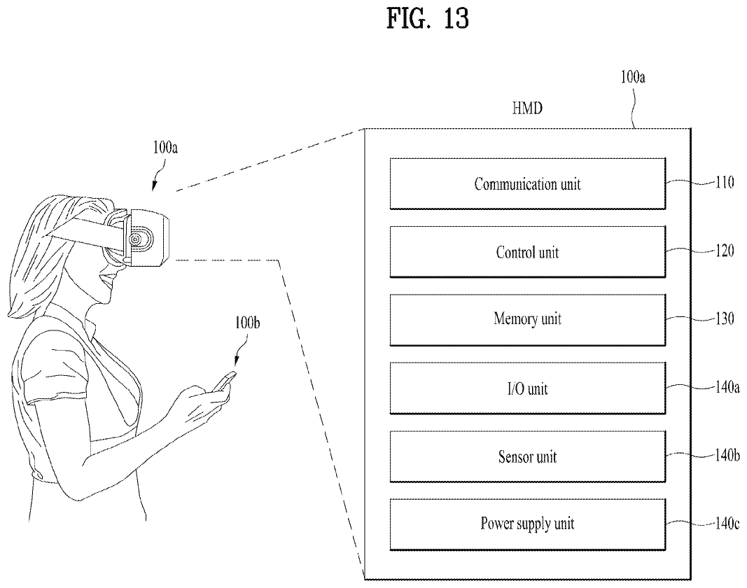

FIG. 13 is a conceptual diagram illustrating an exemplary method for implementing an XR device using an HMD type according to an embodiment of the present disclosure. The above-mentioned embodiments may also be implemented in HMD types shown in FIG. 13.

The HMD-type XR device 100a shown in FIG. 13 may include a communication unit 110, a control unit 120, a memory unit 130, an input/output (I/O) unit 140a, a sensor unit 140b, a power-supply unit 140c, etc. Specifically, the communication unit 110 embedded in the XR device 10a may communicate with a mobile terminal 100b by wire or wirelessly.

FIG. 14 is a conceptual diagram illustrating an exemplary method for implementing an XR device using AR glasses according to an embodiment of the present disclosure. The above-mentioned embodiments may also be implemented in AR glass types shown in FIG. 14.

Referring to FIG. 14, the AR glasses may include a frame, a control unit 200, and an optical display unit 300.

Although the frame may be formed in a shape of glasses worn on the face of the user 10 as shown in FIG. 14, the scope or spirit of the present disclosure is not limited thereto, and it should be noted that the frame may also be formed in a shape of goggles worn in close contact with the face of the user 10.

The frame may include a front frame 110 and first and second side frames.

The front frame 110 may include at least one opening, and may extend in a first horizontal direction (i.e., an X-axis direction). The first and second side frames may extend in the second horizontal direction (i.e., a Y-axis direction) perpendicular to the front frame 110, and may extend in parallel to each other.

The control unit 200 may generate an image to be viewed by the user 10 or may generate the resultant image formed by successive images. The control unit 200 may include an image source configured to create and generate images, a plurality of lenses configured to diffuse and converge light generated from the image source, and the like. The images generated by the control unit 200 may be transferred to the optical display unit 300 through a guide lens P200 disposed between the control unit 200 and the optical display unit 300.

The controller 200 may be fixed to any one of the first and second side frames. For example, the control unit 200 may be fixed to the inside or outside of any one of the side frames, or may be embedded in and integrated with any one of the side frames.

The optical display unit 300 may be formed of a translucent material, so that the optical display unit 300 can display images created by the control unit 200 for recognition of the user 10 and can allow the user to view the external environment through the opening.

The optical display unit 300 may be inserted into and fixed to the opening contained in the front frame 110, or may be located at the rear surface (interposed between the opening and the user 10) of the opening so that the optical display unit 300 may be fixed to the front frame 110. For example, the optical display unit 300 may be located at the rear surface of the opening, and may be fixed to the front frame 110 as an example.

Referring to the XR device shown in FIG. 14, when images are incident upon an incident region S1 of the optical display unit 300 by the control unit 200, image light may be transmitted to an emission region S2 of the optical display unit 300 through the optical display unit 300, images created by the controller 200 can be displayed for recognition of the user 10.

Accordingly, the user 10 may view the external environment through the opening of the frame 100, and at the same time may view the images created by the control unit 200.

As described above, although the present disclosure can be applied to all the 5G communication technology, robot technology, autonomous driving technology, and Artificial Intelligence (AI) technology, following figures illustrate various examples of the present disclosure applicable to multimedia devices such as XR devices, digital signage, and TVs for convenience of description. However, it will be understood that other embodiments implemented by those skilled in the art by combining the examples of the following figures with each other by referring to the examples of the previous figures are also within the scope of the present disclosure.

Specifically, the multimedia device to be described in the following figures can be implemented as any of devices each having a display function without departing from the scope or spirit of the present disclosure, so that the multimedia device is not limited to the XR device and corresponds to the user equipment (UE) mentioned in FIGS. 1 to 14 and the multimedia device shown in the following figures can additionally perform 5G communication.

Particularly, as a device equipped with a projector function of projecting to display an image on a projection body is enough for a multimedia device that will be described with reference to the accompanying drawings, the multimedia device is non-limited by an XR device.

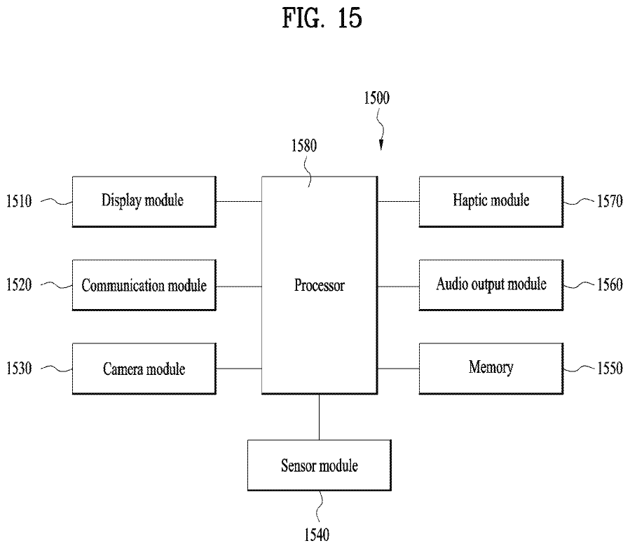

Hereinafter, when a virtual object is disposed in a preview image of a camera representing a real world, if a portion of the virtual object overlaps with a portion of a real object in the preview image, a process for disposing the virtual object based on depths of the real object and the virtual object is described in detail with reference to FIGS. 15 to 29.

In some implementations, an XR device 2500 according to the present disclosure may include any device, which is capable of displaying a virtual object in a preview image received through a camera provided thereto, such as a Head-Mounted Display (HMD), a Head-Up Display (HUD), eyeglass-type AR glasses, a smartphone, a tablet PC, a laptop, a desktop, a TV, a digital signage, etc.

FIG. 15 is a block diagram of an XR device according to one embodiment of the present disclosure.

Referring to FIG. 15, an XR device 1500 of the present disclosure includes a display module 1510, a communication module 1520, a camera module 1530, a sensor module 1540, a memory 1550, an audio output module 1560, a haptic module 1570, and a processor 1580.

The display module 1510 configures a mutually-layered structure with a touch sensor or is integrally formed with the touch sensor, thereby implementing a touchscreen. Such a touchscreen functions as a user input unit providing an input interface between the XR device 1500 and a user and also provides a user interface for manipulating the XR device 1500 to the user. The display module 1510 may visually display all informations processed by the XR device 1500.

The communication module 1520 may include one or more modules enabling wireless communication between the XR device 1500 and a wireless communication system, wireless communication between the XR device 1500 and another external device, or communication between the XR device 1500 and a network having another external device located thereon.

Such a communication module 1520 may include at least one of a broadcast receiving module, a mobile communication module, a wireless internet module, a short range communication module, and a position information module.

The broadcast receiving module receives broadcast signals and/or broadcast related information from an external broadcast management server through a broadcast channel. Here, the broadcast channel may include a satellite channel, a terrestrial wave channel, etc. Through simultaneous broadcast reception or broadcast channel switching of at least two broadcast channels, two or more broadcast receiving modules may be provided to the XR device 1500.

The mobile communication module transceives wireless signals with at least one of a base station, an external terminal, and a server on a mobile communication network established according to the technology standards or communication systems for mobile communications (e.g., GSM (Global System for Mobile communication), CDMA (Code Division Multi Access), WCDMA (Wideband CDMA), HSDPA (High Speed Downlink Packet Access), LTE (Long Term Evolution), etc.). The wireless signals may include a voice call signal, a video call signal, and data of various types according to text/multimedia message transceiving.

The wireless internet mobile refers to a module for a wireless internet access and may be internally or externally coupled to the XR device 1500. The wireless internet module is configured to transceive wireless signals via communication networks according to the wireless internet technologies.

The wireless internet technologies include, for example, WLAN (Wireless LAN), WiFi (Wireless Fidelity) Direct, DLNA (Digital Living Network Alliance), Wibro (Wireless broadband), Wimax (World Interoperability for Microwave Access), HSDPA (High Speed Downlink Packet Access), LTE (Long Term Evolution), etc. The wireless internet module transceives data according to at least one wireless internet technology in a range including internet technologies failing to be listed in the above description.

From the perspective that a wireless internet access by Wibro, HSDPA, GSM, CDMA, WCDMA, LTE, or the like is achieved through a mobile communication network, the wireless internet module performing the wireless internet access through the mobile communication network may be understood as a sort of the mobile communication module.

The short range communication module is configured to facilitate short range communications. Suitable technologies for supporting such short range communications may include Bluetooth, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, and the like. The short range communication module in general supports wireless communications between the XR device 1500 and a wireless communication system, communications between the XR device 1500 and a different external device, or communications between the XR device 1500 and a network where a different external device is located, via a wireless personal area networks.

Here, the different external device may include a wearable device (e.g., a smartwatch, a smart glass, a Head Mounted Display (HMD), etc.) capable of mutually exchanging data with (or linking to) the XR device 1500 according to the present disclosure.

The short range communication module may sense (or recognize) a wearable device, which is capable of communicating with the XR device 1500, around the XR device 1500. Moreover, if the sensed wearable device is a device authenticated to communicate with the XR device 1500, the processor 1580 may send at least one portion of data processed by the XR device 1500 to the wearable device through the short range communication module.

Therefore, a user of the wearable device may use the data processed by the XR device 1500 through the corresponding wearable device. Accordingly, for example, when a phone call is received by the XR device 1500, the user may answer the phone call through the wearable device. When a message is received by the XR device 1500, the user may check the received message through the wearable device.

The position information module is generally configured to obtain a position (or a current position) of the XR device 1500. As a representative example, the position information module includes a Global Position System (GPS) module, a Wireless Fidelity (Wi-Fi) module, or both. For example, when the XR device 1500 uses a GPS module, it may obtain a position of its own using a signal sent from a GPS satellite. For another example, when the XR device 1500 uses the Wi-Fi module, a position of the XR device 1500 may be obtained based on information of a wireless Access Point (AP) which transmits/receives a wireless signal to/from the Wi-Fi module.

In some implementations, according to the present disclosure, the communication module 1520 may receive information on a virtual object to dispose in a preview image received through the camera module 1530 described in the following from an external AR server and then save it to the memory 1550. The virtual object information may include an image of an AR object displayed in a preview image representing a real world and depth information corresponding to a position of the AR object in the preview image. Here, the virtual object may include a 2D virtual object having depth information on one face or a 3D virtual object having depth information on two or more faces.

The camera module 1530 may process image frames of still pictures or video obtained by image sensors in a photo or video capture mode. The processed image frames may be displayed on the display module 1510. The camera module 1530 is mounted on a front or rear side of the XR device 1500, thereby receiving a preview image including at least one real object in a real world.

The sensor module 1540 is typically implemented using one or more sensors configured to sense internal information of the XR device 1500, information on the surrounding environment of the XR device 1500, user information, and the like. For example, the sensor module 1540 may alternatively or additionally include other types of sensors or devices, such as a proximity sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (e.g., a barometer, a hygrometer, a thermometer, a radiation detection sensor, a thermal sensor, and a gas sensor, etc.), and a chemical sensor (e.g., an electronic nose, a health care sensor, a biometric sensor, etc.), to name a few. Meanwhile, the XR device 1500 disclosed in the present specification may be configured to utilize informations obtained from sensor module, and in particular, informations obtained from one or more sensors of the sensor module, and combinations thereof.

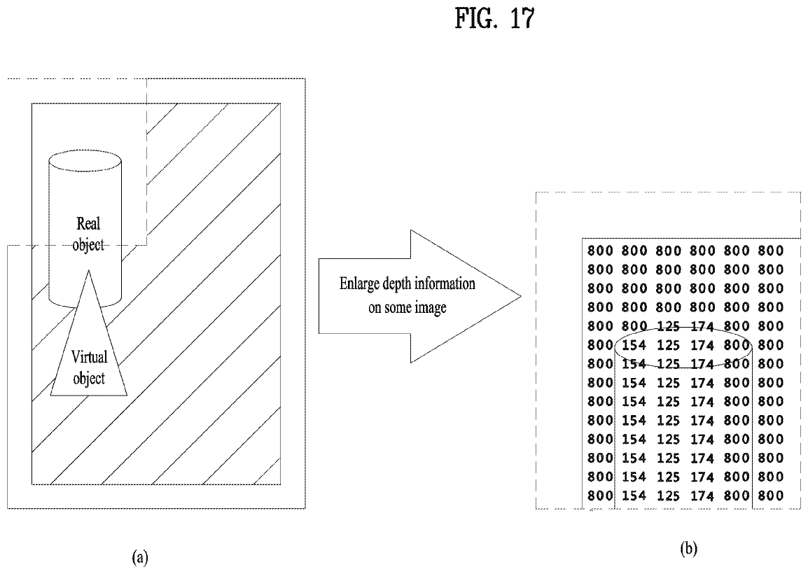

In addition, the sensor module 1540 of the present disclosure includes a Time-Of-Flight (TOF) or 3D sensor configured to obtain depth information of at least one real object in a preview image received through the camera module 1530. The depth information of the real object will be described in detail with reference to FIG. 17 later.

The memory 1550 is typically implemented to store data to support various functions or features of the XR device 1500. For instance, the memory 1550 may be configured to store application programs (or applications) run in the XR device 1500, data or instructions for operations of the XR device 1500, and the like. At least some of these application programs may be downloaded from an external server through wireless communication. Other application programs may be installed on the XR device 1500 at time of manufacturing or shipping, which is typically the case for basic functions of the XR device 1500 (e.g., receiving a call, sending a call, receiving a message, sending a message, etc.). It is common for application programs to be stored in the memory 1550, installed on the XR device 1500, and launched by the processor 1580 to perform an operation (or function) of the XR device 1500.

Moreover, according to the present disclosure, as described above, the memory 1550 may store information on a virtual object to dispose in a preview image received through the camera module 1530.

The audio output module 1560 may output audio data. Such audio data may be received from the communication module 1520 or stored in the memory 1550. The audio data may be outputted in modes such as a call signal reception mode, a phone call mode, a record mode, a voice recognition mode, a broadcast reception mode, etc. The audio output module 1560 may output a sound signal related to a function (e.g., a call signal reception sound, a message reception sound, etc.) performed by the XR device 1500. The audio output module 1560 may include a receiver, a speaker, a buzzer, etc.

A haptic module 1570 may be configured to generate various tactile effects that a user can feel, perceive, or otherwise experience. A typical example of a tactile effect generated by the haptic module 1570 is vibration. The strength, pattern and the like of the vibration generated by the haptic module 1570 may be controlled by user selection or setting by the controller. For example, the haptic module 1570 may output different vibrations in a combining manner or a sequential manner.

The haptic module 1570 may produce a variety of tactile effects in addition to vibrations. Such tactile effects may include effects by stimuli such as pin arrangements for vertical motion on a contact skin surface, injection or suction power of air through a nozzle or inlet, slippage on a skin surface, contact with electrodes, and electrostatic force, etc. and effects by reactivation of hot and cold temperature sensations using endothermic or exothermic elements.

The haptic module 1570 may deliver tactile effects through direct contact, as well as implement them so that users can feel tactile effects through muscular senses of fingers and arms. Two or more haptic module 1570 may be provided depending on the configuration type of the XR device 1500.

The processor 1580 may control the overall operations of the XR device 1500 according to the present disclosure, and further the processor 1580 may control any of the components viewed above, or in combination, to implement various embodiments described below on the XR device 1500 according to the present disclosure.

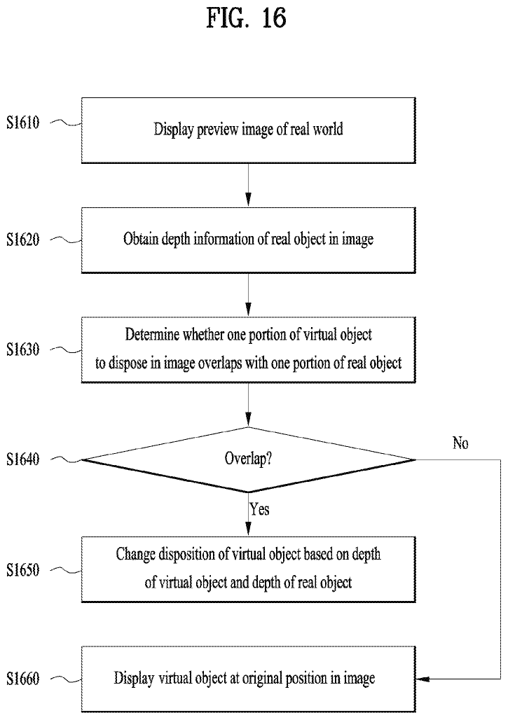

Hereinafter, a control process of the processor 1580 is described in detail with reference to FIGS. 16 to 29.

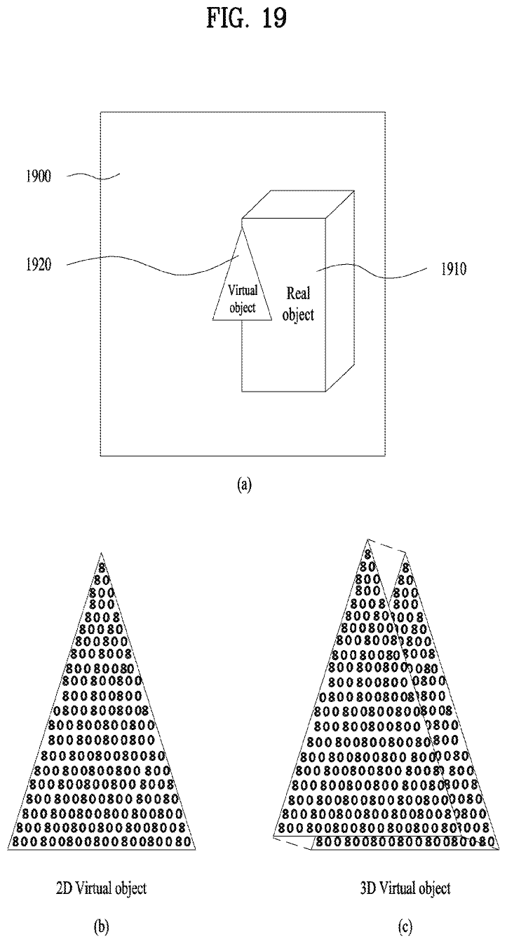

FIG. 16 is a flowchart of a process for disposing a virtual object in an XR device according to one embodiment of the present disclosure. FIG. 17 is a diagram to describe depth information of a real object according to one embodiment of the present disclosure. FIG. 18 is a diagram to describe a process for recognizing and extracting a real object in a preview image according to one embodiment of the present disclosure. FIG. 19 is a diagram to describe depth information when a virtual object is a 2D or 3D virtual object according to one embodiment of the present disclosure.

Referring to FIGS. 16 to 19, if an AR mode is activated, the processor 1580 activates the camera module 1530, receives a preview image including at least one real object of a real word seen in front of the XR device 1500 through the camera module 1530, and displays the received preview image on the display module 1510 [S1610].

If an AR virtual object disposition mode for disposing to display at least one virtual object in the preview image is activated by being selected by a user, the processor 1580 activates the sensor module 1540 and then obtains depth information of at least one real object included in the preview image through the activated sensor module 1540 [S1620].

For example, FIG. 17(a) shows that a real object and a virtual object included in the preview image overlap with each other in part, and FIG. 17(b) shows depth information including depth values for pixels in an image region corresponding to the real object.

FIG. 18(a) shows that a shape of the real object in the preview image is recognized, and FIG. 18(b) shows that a real object image corresponding to the recognized shape of the real object is extracted from the preview image.

Namely, the processor 1580 generates depth information on depth values for the respective pixels in an image region corresponding to the real object through the TOF or 3D sensor in the sensor module 1540, recognizes the real object from the preview image using at least one of artificial intelligence technology, shape recognition algorithm, edge detection, line detection and color detection, and then extracts a partial image corresponding to the real object from the preview image.

FIG. 19(a) shows that a portion of a real object 1910 and a portion of a virtual object 1920 are disposed in a preview image in a manner of overlapping with each other, FIG. 19(b) shows that the virtual object 1920 is a virtual object of a 2D type having a single face, and FIG. 19(c) shows that the virtual object 1920 is a virtual object of a 3D type having two or more faces.

Here, in case of the 2D virtual object, it is a virtual object that provides a simple image or text only. And, relative depth is not necessary. Namely, since the 2D virtual object has no depth, it needs to have depth information in front only.

Yet, in case of the 3D virtual object [e.g., only a front face and a rear face are shown on FIG. 19(c)], if depth information of a front side is obtained, relative depth information on the rest of 5 faces (i.e., rear side, left side, right side, top side and bottom side) may be calculated using the depth information of the front side. For example, FIG. 19(c) shows that there is a difference of a depth value “70” between the front side and the rear side.

As described above, the depth information of the 2D or 3D virtual object can be set/changed by a user of the XR device 1500 through a virtual object depth adjustment User Interface (UI) or an environment setting menu provided by the XR device 1500 or set/changed by an AR server providing the 2D or 3D virtual object.

Subsequently, if at least one virtual object is disposed at a specific position in the preview image, the processor 1580 determines whether a portion of the virtual object to be disposed at the specific position overlaps with a portion of at least one real object in the preview image [S1630].

If the portion of the virtual object fails to overlap with the portion of the at least one real object in the preview image, the processor 1580 displays the virtual object in a manner of disposing the virtual object at the specific position in the preview image [S1660].

On the contrary, if the portion of the virtual object overlaps with the portion of the at least one real object in the preview image, the processor 1580 [S1640], the processor 1580 changes the disposition of at least one of the virtual object and the real object based on the depth information of the virtual object and the depth information of the real object [S1650].

For example, based on the depth information of the virtual object and the depth information of the real object, the processor 1580 may first dispose one of the virtual object and the real object, which has a greater depth (seen farther), and then dispose the other in a manner of overlaying the first disposed object.

Namely, if determining that the depth of the virtual object is greater than that of the real object in a state that the portion of the virtual object overlaps with the portion of the real object, the processor 1580 disposes the virtual object behind the real object in the preview image based on the depth information of the virtual object and displays the portion of the real object on the portion of the virtual object by overlay, thereby disposing the portion of the virtual object blocked by the portion of the real object.

On the contrary, if determining that the depth of the real object is greater than that of the virtual object in a state that the portion of the virtual object overlaps with the portion of the real object, the processor 1580 disposes the virtual object ahead of the real object in the preview image based on the depth information of the virtual object and displays the portion of the virtual object on the portion of the real object by overlay, thereby disposing the portion of the real object covered by the portion of the virtual object.

In some implementations, while depths of the virtual and real objects are equal to each other or a depth range of the virtual object belongs to a depth range of the real object, if a portion of the virtual object overlaps with a portion of the real object, the processor 1580 determines that the virtual object is disposed at a position for penetration into the real object and may restrict that the virtual object from being disposed at the specific position in the preview image.

As a portion of the virtual object penetrates a portion of the real object, if the virtual object is restricted from being disposed as the specific position in the preview image, the processor 1580 may output feedback for informing a user that the disposition of the virtual object is restricted.

In doing so, the feedback may include visual feedback displayed on the display module 1510, auditory feedback outputted through the audio output module 1560, haptic feedback outputted through the haptic module 1570, or combination of two or more thereof.

If a portion of the virtual object penetrates a portion of the real object, the processor 1580 may move and dispose the virtual object in a direction opposite to the penetration direction within a range that the portion of the virtual object is not penetrated by the portion of the real object.

While the depth of the virtual object and the depth of the real object are equal to each other or a depth range of the virtual object belongs to a depth range of the real object, if a prescribed edge of the virtual object contacts with a prescribed edge of the real object, the processor 1580 may restrict movement of the virtual object in a direction of contacting with the real object.

While the depth of the virtual object and the depth of the real object are equal to each other or a depth range of the virtual object belongs to a depth range of the real object, if a portion of the virtual object and a portion of the real object overlap with each other, the processor 1580 may restrict movement of the virtual object in a direction of overlapping with the real object.

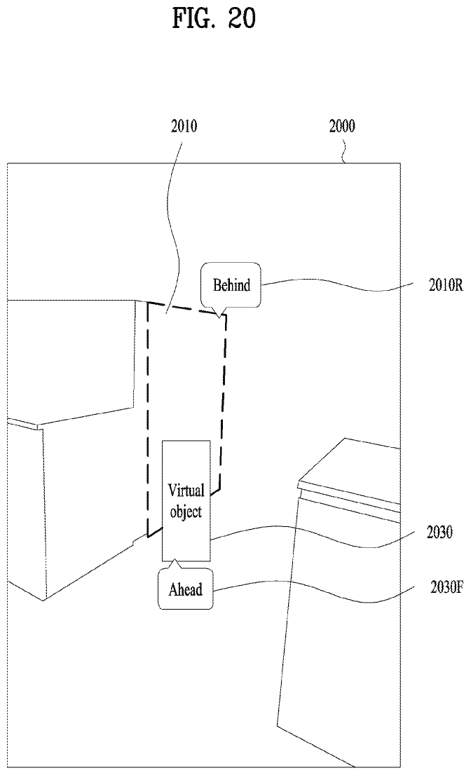

FIG. 20 is a diagram to describe a process for disposing a 2D virtual object ahead of a real object according to one embodiment of the present disclosure.

Referring to FIG. 20, while a portion of a first real object 2010 and a portion of a 2D virtual object 2030 overlap with each other in a preview image 2000, if the 2D virtual object 2030 is located ahead of the first real object 2010 based on depth informations of the 2D virtual object 2030 and the first real object 2010, the processor 1580 displays the 2D virtual object 2030 ahead of the first real object 2010 in a manner that a portion of the 2D virtual object overlays a portion of the first real object 2010, thereby representing that the 2D virtual object 2030 is located ahead of the first real object 2010.

The processor 1580 displays a first indicator 2030F indicating that the 2D virtual object 2030 is located ahead of the first real object 2010 and a second indicator 2010R indicating that the first real object 2010 is located behind the 2D virtual object 2030.

In this case, when the 2D virtual object 2030 is touched and selected by a user, the processor 1580 may display the first indicator 2030F. When the first real object 2010 is touched and selected by a user, the processor 1580 may display the second indicator 2010R.

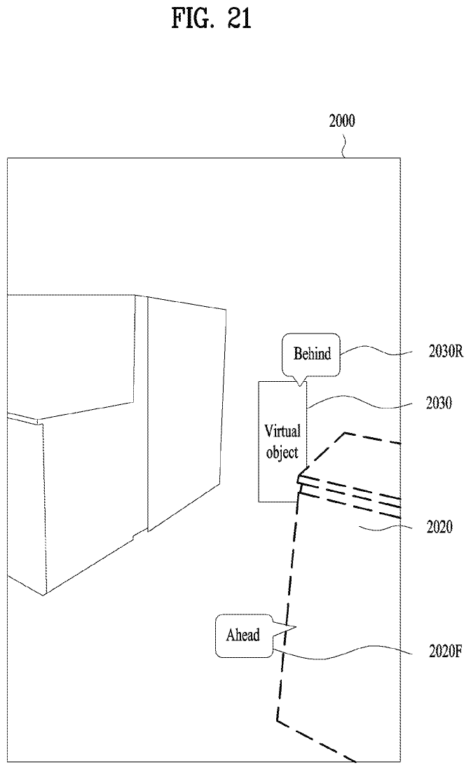

FIG. 21 is a diagram to describe a process for disposing a 2D virtual object behind a real object according to one embodiment of the present disclosure.

Referring to FIG. 21, while a portion of a second real object 2020 and a portion of a 2D virtual object 2030 overlap with each other in a preview image 2000, if the 2D virtual object 2030 is located behind the second real object 2020 based on depth informations of the 2D virtual object 2030 and the second real object 2020, the processor 1580 displays the 2D virtual object 2030 behind the second real object 2020 in a manner that a portion of the second real object 2020 overlays a portion of the 2D virtual object 2030, thereby representing that the 2D virtual object 2030 is located behind the second real object 2020.

The processor 1580 displays a third indicator 2030R indicating that the 2D virtual object 2030 is located behind the second real object 2020 and a fourth indicator 2020F indicating that the second real object 2020 is located ahead of the 2D virtual object 2030.

In this case, when the 2D virtual object 2030 is touched and selected by a user, the processor 1580 may display the third indicator 2030R. When the second real object 2020 is touched and selected by a user, the processor 1580 may display the fourth indicator 2020F.

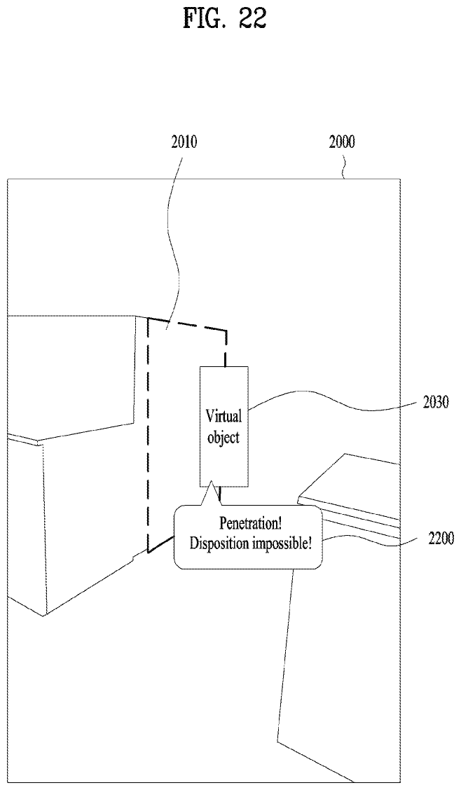

FIG. 22 is a diagram to describe a situation that disposition is impossible because a 2D virtual object penetrates a real object according to one embodiment of the present disclosure.

Referring to FIG. 22, while a depth of a 2D virtual object 2030 and a depth of a first real object 2010 are equal to each other or a depth range of the 2D virtual object 2030 belongs to a depth range of the first real object 2010, if a portion of the 2D virtual object 2030 overlaps with a portion of the first real object 2010, the processor 1580 determines that the 2D virtual object 2030 is disposed at a position for penetration into the first real object 2010 and may restrict the 2D virtual object 2030 from being disposed at the specific position in a preview image 2000.

In this case, the processor 1580 may display a fifth indicator 2200 as feedback on indicating that the disposition of the 2D virtual object 2030 is restricted.

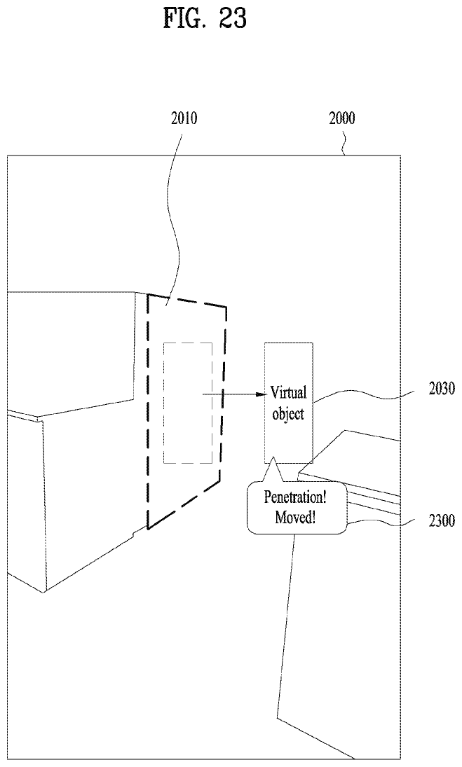

FIG. 23 is a diagram to describe a process for moving a 2D virtual object to avoid penetration into a real object according to one embodiment of the present disclosure.

Referring to FIG. 23, if a portion of the 2D virtual object 2030 penetrates a portion of the first real object 2010, as shown in FIG. 22, the processor 1580 may move and dispose the 2D virtual object 2030 in a direction opposite to the penetration direction within a range that a portion of the 2D virtual object 2030 is not penetrated by a portion of the first real object 2010.

In this case, the processor 1580 may display a sixth indicator 2300 indicating that the 2D virtual object 2030 is moved to avoid penetration.

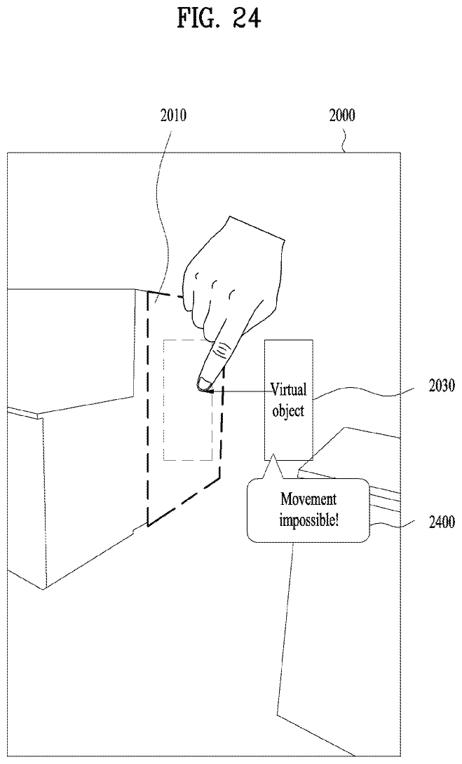

FIG. 24 is a diagram to describe a process for restricting a 2D virtual object and a real object from moving in a contact direction according to one embodiment of the present disclosure.

Referring to FIG. 24, while the depth of the 2D virtual object 2030 and the depth of the first real object 2010 are equal to each other or a depth range of the 2D virtual object 2030 belongs to a depth range of the first real object 2010, if a prescribed edge of the 2D virtual object 2030 contacts with a prescribed edge of the first real object 2010, the processor 1580 may restrict movement of the 2D virtual object 2030 in a direction of contacting with the first real object 2010.

In this case, the processor 1580 may display a seventh indicator 2400 indicating that the 2D virtual object 2030 is unable to move in the direction of contacting with the first real object 2010.

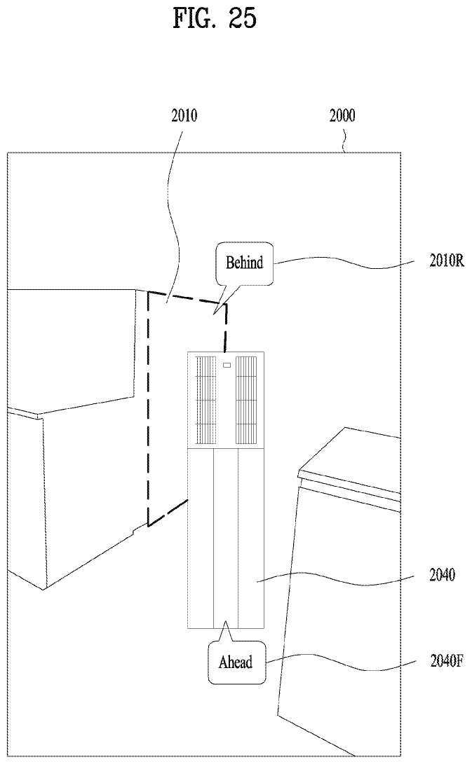

FIG. 25 is a diagram to describe a process for disposing a 3D virtual object ahead of a real object according to one embodiment of the present disclosure.

Referring to FIG. 25, while a portion of a first real object 2010 and a portion of a 3D virtual object 2040 overlap with each other in a preview image 2000, if the 3D virtual object 2040 is located ahead of the first real object 2010 based on depth informations of the 3D virtual object 2040 and the first real object 2010, the processor 1580 displays the 3D virtual object 2040 ahead of the first real object 2010 in a manner that a portion of the 3D virtual object 2040 overlays a portion of the first real object 2010, thereby representing that the 3D virtual object 2040 is located ahead of the first real object 2010.

The processor 1580 displays an eighth indicator 2040F indicating that the 3D virtual object 2040 is located ahead of the first real object 2010 and a ninth indicator 2010R indicating that the first real object 2010 is located behind the 3D virtual object 2040.

In this case, when the 3D virtual object 2040 is touched and selected by a user, the processor 1580 may display the eighth indicator 2040F. When the first real object 2010 is touched and selected by a user, the processor 1580 may display the ninth indicator 2010R.

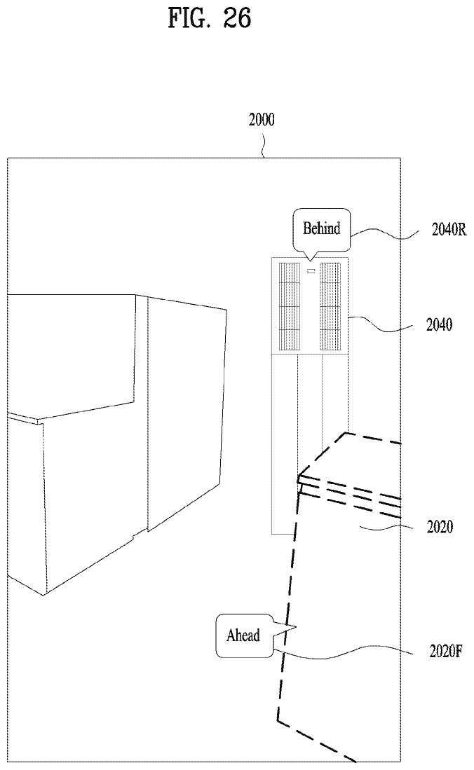

FIG. 26 is a diagram to describe a process for disposing a 3D virtual object behind a real object according to one embodiment of the present disclosure.

Referring to FIG. 26, while a portion of a second real object 2020 and a portion of a 3D virtual object 2040 overlap with each other in a preview image 2000, if the 3D virtual object 2040 is located behind the second real object 2020 based on depth informations of the 3D virtual object 2040 and the second real object 2020, the processor 1580 displays the 3D virtual object 2040 behind the second real object 2020 in a manner that a portion of the second real object 2020 overlays a portion of the 3D virtual object 2040, thereby representing that the 3D virtual object 2040 is located behind the second real object 2020.

The processor 1580 displays a tenth indicator 2040R indicating that the 3D virtual object 2040 is located behind the second real object 2020 and an eleventh indicator 2020F indicating that the second real object 2020 is located ahead of the 3D virtual object 2040.

In this case, when the 3D virtual object 2040 is touched and selected by a user, the processor 1580 may display the tenth indicator 2040R. When the second real object 2020 is touched and selected by a user, the processor 1580 may display the eleventh indicator 2020F.

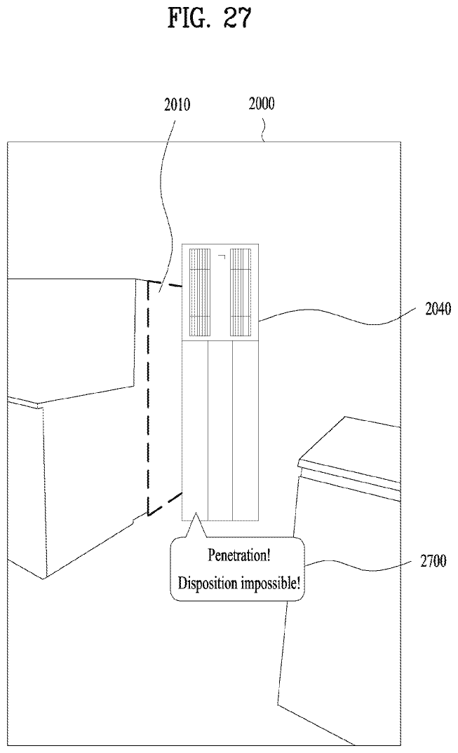

FIG. 27 is a diagram to describe a situation that disposition is impossible because a 3D virtual object penetrates a real object according to one embodiment of the present disclosure.

Referring to FIG. 27, while a depth of a 3D virtual object 2040 and a depth of a first real object 2010 are equal to each other or a depth range of the 3D virtual object 2040 belongs to a depth range of the first real object 2010, if a portion of the 3D virtual object 2040 overlaps with a portion of the first real object 2010, the processor 1580 determines that the 3D virtual object 2040 is disposed at a position for penetration into the first real object 2010 and may restrict the 3D virtual object 2040 from being disposed at the specific position in a preview image 2000.

In this case, the processor 1580 may display a twelfth indicator 2700 as feedback on indicating that the disposition of the 3D virtual object 2040 is restricted.

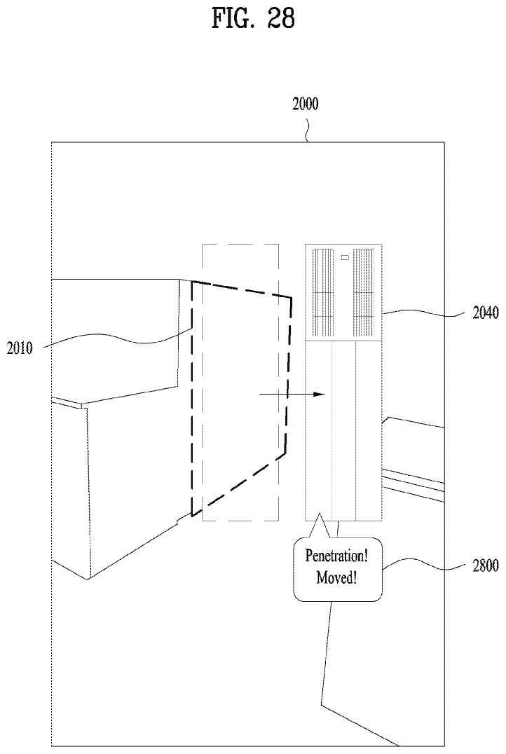

FIG. 28 is a diagram to describe a process for moving a 3D virtual object to avoid penetration into a real object according to one embodiment of the present disclosure.

Referring to FIG. 28, if a portion of the 3D virtual object 2040 penetrates a portion of the first real object 2010, as shown in FIG. 27, the processor 1580 may move and dispose the 3D virtual object 2040 in a direction opposite to the penetration direction within a range that a portion of the 3D virtual object 2040 is not penetrated by a portion of the first real object 2010.

In this case, the processor 1580 may display a thirteenth indicator 2800 indicating that the 3D virtual object 2040 is moved to avoid penetration.

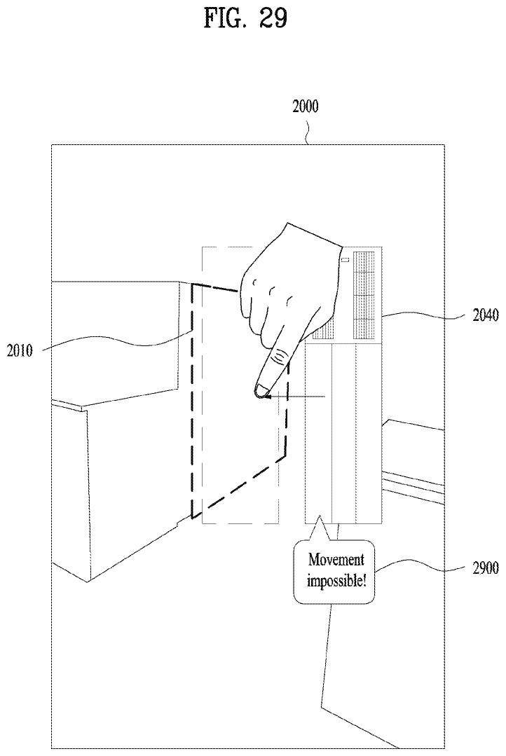

FIG. 29 is a diagram to describe a process for restricting a 3D virtual object and a real object from moving in a contact direction according to one embodiment of the present disclosure.

Referring to FIG. 29, while the depth of the 3D virtual object 2040 and the depth of the first real object 2010 are equal to each other or a depth range of the 3D virtual object 2040 belongs to a depth range of the first real object 2010, if a prescribed edge of the 3D virtual object 2040 contacts with a prescribed edge of the first real object 2010, the processor 1580 may restrict movement of the 3D virtual object 2040 in a direction of contacting with the first real object 2010.

In this case, the processor 1580 may display a fourteenth indicator 2900 indicating that the 3D virtual object 2040 is unable to move in the direction of contacting with the first real object 2010.

According to one of various embodiments of the present disclosure, a virtual object is disposed based on depths of a real object and the virtual object in a preview image indicating a real world, whereby a user can intuitively recognize whether the virtual object is substantially located ahead of or behind the real object.

Although the present specification has been described with reference to the accompanying drawing, it will be apparent to those skilled in the art that the present specification can be embodied in other specific forms without departing from the spirit and essential characteristics of the specification. The scope of the specification should be determined by reasonable interpretation of the appended claims and all change which comes within the equivalent scope of the specification are included in the scope of the specification.

1. An extended reality (XR) device, comprising:
a camera configured to receive an image including at least one real object of a real world;
a display configured to display the image;
a sensor obtaining depth information of the real object; and
a processor operably coupled with the camera, the display and the sensor, and configured to:
when at least one virtual object is disposed in the image, if a portion of the virtual object overlaps with a portion of the real object, change disposition of at least one of the virtual object and the real object based on depth information of the virtual object and the depth information of the real object,
when a portion of the virtual object penetrates a portion of the real object, avoid placing the virtual object in the image, and
display feedback on indicating that the virtual object cannot be placed in the image while the portion of the virtual object penetrates the portion of the real object.

2. The XR device of claim 1, wherein based on the depth information of the virtual object and the depth information of the real object, the processor is further configured to dispose one of the virtual object and the real object, which has a greater depth, first and then disposes the other in a manner of overlaying the first disposed object.

3. The XR device of claim 2, wherein if determining that a depth of the virtual object is greater than that of the real object, the processor is further configured to dispose a portion of the virtual object to be blocked by a portion of the real object.

4. The XR device of claim 2, wherein if determining that a depth of the real object is greater than that of the virtual object, the processor is further configured to dispose a portion of the real object to be blocked by a portion of the virtual object.

5. (canceled)

6. The XR device of claim 1, wherein while a depth of the virtual object and a depth of the real object are equal to each other, if a portion of the virtual object overlaps with a portion of the real object, the processor is further configured to determine that the virtual object penetrates the real object.

7. (canceled)

8. The XR device of claim 1, wherein if a portion of the virtual object penetrates a portion of the real object, the processor is further configured to move the virtual object so that the portion of the virtual object does not penetrate the portion of the real object.

9. The XR device of claim 1, wherein if a portion of the virtual object and a portion of the real object contact with each other, the processor is further configured to restrict movement of the virtual object in a direction of contacting with the real object.

10. The XR device of claim 1, wherein if a portion of the virtual object and a portion of the real object overlap with each other, the processor is further configured to restrict movement of the virtual object in a direction of overlapping with the real object.

11. A method for controlling an extended reality (XR) device, the method comprising:
receiving an image including at least one real object of a real world through a camera;
displaying the image;
obtaining depth information of the real object through a sensor; and
when at least one virtual object is disposed in the image, if a portion of the virtual object overlaps with a portion of the real object, changing disposition of at least one of the virtual object and the real object based on depth information of the virtual object and the depth information of the real object,
when a portion of the virtual object penetrates a portion of the real object, avoiding placing the virtual object in the image; and
displaying feedback on indicating that the virtual object cannot be placed in the image while the portion of the virtual object penetrates the portion of the real object.

12. The method of claim 11, wherein the changing the disposition comprises, based on the depth information of the virtual object and the depth information of the real object, disposing one of the virtual object and the real object, which has a greater depth, first and then disposing the other in a manner of overlaying the first disposed object.

13. The method of claim 12, wherein the changing the disposition comprises, if determining that a depth of the virtual object is greater than that of the real object, disposing a portion of the virtual object to be blocked by a portion of the real object.

14. The method of claim 12, wherein the changing the disposition comprises, if determining that a depth of the real object is greater than that of the virtual object, disposing a portion of the real object to be blocked by a portion of the virtual object.

15. (canceled)

16. The method of claim 11, further comprising, while a depth of the virtual object and a depth of the real object are equal to each other, if a portion of the virtual object overlaps with a portion of the real object, determining that the virtual object penetrates the real object.

17. (canceled)

18. The method of claim 11, further comprising, if a portion of the virtual object penetrates a portion of the real object, moving the virtual object so that the portion of the virtual object does not penetrate the portion of the real object.

19. The method of claim 11, further comprising, if a portion of the virtual object and a portion of the real object contact with each other, restricting movement of the virtual object in a direction of contacting with the real object.

20. The method of claim 11, further comprising, if a portion of the virtual object and a portion of the real object overlap with each other, restricting movement of the virtual object in a direction of overlapping with the real object.
